(19) United States
(12) Patent Application Publication
(10) Pub. No.: US 2015/0088557 A1
(43) Pub. Date: Mar. 26, 2015

(54) ONLINE CLAIMS SUBMISSION AND ADJUDICATION SYSTEM

(71) Applicant: Symbility Health Inc., Toronto (CA)

(72) Inventors: Mark-Olivier Huynh, Montreal (CA); Richard Adair, Toronto (CA); Jason Zhu, Toronto (CA); Adam Schooler, Toronto (CA); Richard Stevens, Toronto (CA); Tyler Johnston, Toronto (CA)

(21) Appl. No.: 14/396,349

(22) PCT Filed: Feb. 19, 2013
(86) PCT No.: PCT/CA2013/000150

§ 371 Date: Oct. 22, 2014

Related U.S. Application Data
(60) Provisional application No. 61/636,690, filed on Apr. 22, 2012.

(51) Int. Cl. G06Q 40/08

(52) U.S. Cl. CPC G06Q 40/08
USPC 705/4

(57) ABSTRACT

The present invention relates to online claim submission adjudication, verification and rating systems, including systems for determining the accuracy of online claim submissions and detecting errors in association with online claim submissions. The present invention is directed to methods to identify claims submitted online that may be targeted for further processing (e.g. real time or other manual auditing). An online adjudication process of the present invention allows a carrier or payor to determine whether auditing is recommended.

### CROSS REFERENCE TO OTHER APPLICATIONS

This application claims priority from U.S. patent application Ser. No. 61/636,690 filed Apr. 22, 2012, which is incorporated herein by reference for all purposes.

### FIELD OF INVENTION

The present invention relates to online claim submission adjudication, verification and rating systems, including systems for determining the accuracy of online claim submissions and detecting errors in association with online claim submissions.

### BACKGROUND TO THE INVENTION

Commercial insurance and other expense/risk management tools provide coverage (e.g. payment or re-imbursement) for many different types of exposures. These include several major lines of coverage, e.g., property, general liability, automobile, and workers compensation. There are many other types of specialty coverage and many more types of subcoverages within the major lines of coverage. Benefit plans, such as employment benefit plans, may also provide for re-imbursement of specific expenses.

Industry trends have been moving towards an increasing presence of technological solutions to enhance the user, member or beneficiary experience while part of a reimbursement program (e.g. an insurance policy, employee benefits program, etc.). Along with online portals where members can view their experience online, the industry is moving towards submission of requests for reimbursements (e.g. claims) electronically through a computer or computer network (i.e. online) to improve efficiencies in the submission, review, and adjudication of any such claim submitted electronically. The benefits of offering this type of service include reduced submission time, fewer resources required than with hardcopy or paper submissions, and increased user/beneficiary/member satisfaction.

Currently, claims, such as, for example, insurance claims, benefit plan claims, etc. submitted online (e.g. electronically via a device connected to a computer network) may often be submitted with errors. In addition, the ability to submit fraudulent claims can also be high with online claim submissions. Prior art solutions to addressing the possibility of errors and fraudulent transactions have included manual and/or offline verification, adjudication and/or audit functions, which involve direct human intervention. Where no manual intervention is provided, claim errors and fraudulent claims can occur with greater frequency. When manual intervention is introduced, however, increased costs and slower claim processing times result.

As a drawback, online (e.g. through a computer or computer network) claim submission also increases the potential for errors in submitted claims, which creates a need for sophisticated auditing, verification, authentication and/or adjudication procedures and processes to mitigate the risk of processing of inaccurate or incomplete submissions. To combat this, monitoring and audit procedures and protocols have been put in place. However, these procedures and protocols may be manual and may be subject to increase costs and time as noted above. As such, an improved method for validating, authenticating and adjudicating claims is needed.

### SUMMARY OF THE INVENTION

By using embodiments of the present invention, claim specific information (such as that submitted in a claim) can be verified, authenticated, graded/rated and/or adjudicated with respect to each claim without manual intervention.

Embodiments of the present invention may use datum or data mining or “scraping” (e.g. where an optical character recognition (OCR) algorithm is employed to extract text based on the pixilated bitmap data corresponding to an area of a scanned document) to identify and read (e.g. “lift”) claim datum or data from an electronically submitted document to verify or authenticate the claim datum or data and provide a grading or weighting of the accuracy thereof based on previously defined verification or adjudication criteria. In a preferred embodiment of the present invention, users/members/beneficiaries may submit a request for reimbursement electronically (e.g. make a claim electronically), online and with real-time customizable adjudication processes to minimize fraudulent submissions.

The introduction of the present invention can allow payors/carriers to configure automated adjudication processes to require electronic submission of a proof of claim, loss, benefit, etc. with an initial claim submission. By utilizing scraping technology to lift information from the electronically submitted proof of claim, loss, benefit, etc. documentation, payors/carriers can have the ability to implement a system which compares the details of the claim submission against the information lifted from the proof of claim, loss, benefit, etc. with verification datum or data so as to authenticate and adjudicate the information provided in the claim submission to determine whether further processing is required, such as, for example, a further review or audit. The embodiments of the present invention can provide an automated authentication and adjudication processes to reduce the amount of manual intervention thus improving efficiencies when considering such claims and increasing the accuracy of claim reimbursements or payments.

The integration process can identify fields completed when submitting a claim in a third party's interface (e.g. software of a carrier/payor) and assess the electronically submitted proof of claim, loss, benefit, etc. documentation against anticipated, expected or predefined criteria. Anticipated, predetermined or predefined input criteria can vary by type of claim, such as, for example, dental or prescription drug claims, and such proof documentation may each include different anticipated or carrier/payor predefined values. In another embodiment, such criteria may vary by type of loss, or type of benefit. After scraping the proof documentation, an assessment can take place that compares the values of the predetermined input criteria submitted through the third party's interface against the data lifted through the scraping process as well as the expected values of the predetermined input codes. Once this assessment or authentication is complete, a possible risk of an error in a claim can be generated and reported via graded or weighted verification criteria, which can be based on the parameters outlined by a payor/carrier. The adjudicating system can identify errors associated with a claim and can determine the relative risk value against the minimum requirements of the payor/carrier. Following the authentication and adjudicating of a submitted claim, reporting to the payor/carrier can indicate which submissions should be subject to further review or consideration.

Possible applications for the embodiments of the present invention include, for example, any online submission where electronic documentation could be included for data verification.

A broad aspect of the present invention is directed to an automated method for adjudicating a claim submitted though a network ready device, the method comprising: (a) inputting at least one claim datum, the at least one claim datum having at least one corresponding claim datum category, the claim datum category having a value and a verification datum, the verification datum having a numeric value; (b) comparing the at least one claim datum from step (a) with the value of the claim datum category, determining if the value of the claim datum category and the claim datum match and where the value of the claim datum category and the claim datum match assigning the numeric value of the verification datum to a claim adjudication value; (c) determining if the claim adjudication value is greater than or equal to an adjudication threshold wherein: (i) if the claim adjudication value is not greater than or equal to the adjudication threshold, the claim is targeted for further processing; and (ii) if the claim adjudication value is greater than or equal to the adjudication threshold the claim is targeted to be paid.

A preferred embodiment of the present invention is directed to the above noted method, wherein step (a) further comprises a user inputting the at least one claim datum via a GUI in the network ready device.

Yet another preferred embodiment is directed to the above noted method, wherein inputting of step (a) further comprises: the manual inputting of a first at least one claim datum by the user through the GUI; obtaining a second at least one claim datum from an electronic copy of a record; and comparing the first and second at least one claim datum and determining if the first and second at least one claim datum are sufficiently similar to be considered to match wherein if the first and second at least one claim datum match proceeding with step (b).

Yet another preferred embodiment is directed to the above noted method wherein the proof of loss or expense is scrapped to obtain the second at least one claim datum.

Yet another preferred embodiment is directed to the above noted method wherein the value of the at least one claim datum is an alphanumeric value.

Yet another preferred embodiment is directed to the above noted method wherein the value and the verification datum of the at least one claim datum are defined by a payor prior to the submission of the claim by the user.

Yet another preferred embodiment is directed to a non-transitory computer readable media having program instructions for causing a computer system to perform a method for adjudicating a claim submitted though a network ready device, the method comprising: (a) inputting at least one claim datum, the at least one claim datum having at least one corresponding claim datum category, the claim datum category having a value and a verification datum, the pre-defined verification datum having a numeric value; (b) comparing the at least one claim datum from step (a) with the pre-defined value of the claim datum category, determining if the value of the claim datum category and the claim datum match and where the value of the claim datum category and the claim datum match assigning the numeric value of the pre-defined verification datum to a claim adjudication value; (c) determining if the claim adjudication value is greater than or equal to a pre-defined adjudication threshold wherein: if the claim adjudication value is not greater than or equal to the pre-defined adjudication threshold, the claim is targeted for further processing; and if the claim adjudication value is greater than or equal to the pre-defined adjudication threshold the claim is targeted to be paid.

Yet another preferred embodiment is directed to a computer system performing a method for adjudicating a claim submitted though a network ready device, the system comprising: (a) a processor; and (b) a program storage device communicatively coupled to the processor wherein the processor is programmed to: (i) obtain at least one claim datum, the at least one claim datum having at least one corresponding claim datum category, the claim datum category having a value and a verification datum, the pre-defined verification datum having a numeric value; (ii) compare the at least one claim datum from step (a) with the pre-defined value of the claim datum category, determine if the value of the claim datum category and the claim datum match and where the value of the claim datum category and the claim datum match assign the numeric value of the pre-defined verification datum to a claim adjudication value; (iii) determine if the claim adjudication value is greater than or equal to a pre-defined adjudication threshold wherein: (A) if the claim adjudication value is not greater than or equal to the pre-defined adjudication threshold, the claim is targeted for further processing; and (B) if the claim adjudication value is greater than or equal to the pre-defined adjudication threshold the claim is targeted to be paid.

### BRIEF DESCRIPTION OF THE DRAWINGS

The foregoing and other objects, features and advantages of the present invention should become apparent from the following description when taken in conjunction with the accompanying drawings.

FIG. 1 is a flow chart illustrating a process for online claim adjudication according to the present invention;

FIG. 2 is an illustration of one embodiment of the present invention;

FIG. 3 is an illustration of another embodiment of the present invention;

FIG. 4 is an illustration of yet another block diagram showing a schematic construction of a copy prevention apparatus according to the present invention;

FIGS. 5 to 13 are illustrations of yet another embodiment of the present invention;

FIG. 14 is a table illustrating an embodiment of the weighting criteria of the present invention;

FIG. 15 is an illustration of yet another embodiment of the present invention;

FIGS. 16 and 17 are flow charts illustrating a process for online claim adjudication according to the present invention; and

FIGS. 18 to 26 are illustrations of yet another embodiment of the present invention.

### DESCRIPTION OF THE PREFERRED EMBODIMENTS

The description that follows, and the embodiments described therein, is provided by way of illustration of an example, or examples, of particular embodiments of the principles and aspects of the present invention. These examples are provided for the purposes of explanation, and not of limitation, of those principles and of the invention.

It should also be appreciated that the present invention can be implemented in numerous ways, including as a process, method, an apparatus, a system, a device, a method, or a computer readable medium such as a computer readable storage medium or a computer network wherein program instructions are sent over a network (e.g. optical or electronic communication links). In this specification, these implementations, or any other form that the invention may take, may be referred to as processes. In general, the order of the steps of the disclosed processes may be altered within the scope of the invention.

Preferred embodiments of the present invention can be implemented in numerous configurations depending on implementation choices based upon the principles described herein. Various specific aspects are disclosed, which are illustrative embodiments not to be construed as limiting the scope of the disclosure. One aspect of the disclosure is for a datum or data driven method, computer program product, apparatus, and system for claim adjudication in context of an executing software application. Although the present specification describes components and functions implemented in the embodiments with reference to standards and protocols known to a person skilled in the art, the present disclosures as well as the embodiments of the present invention are not limited to any specific standard or protocol. Each of the standards for mobile computing, including the internet and other forms of computer network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

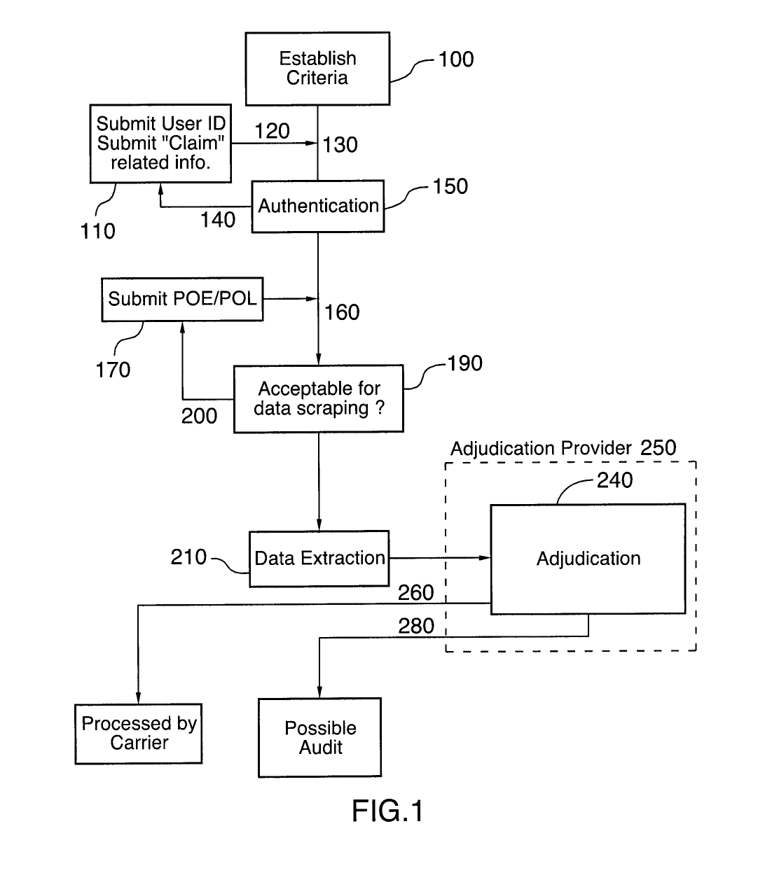

A preferred embodiment of the present invention can be to identify which of submitted claims for reimbursement are to be targeted for further processing (e.g. real time or other manual auditing). This online adjudication step may be separate from any auditing step that may be conducted (see 280 of FIG. 1). For example, the online adjudication process may be conducted by an entity separate and apart from the carrier (e.g. outside of the carrier's systems or abilities). In a preferred embodiment, any auditing based on the online adjudication process may be conducted by the carrier (see 260 of FIG. 1). The online adjudication process of the present invention allows the carrier or adjudication provider to determine whether auditing is recommended.

A person skilled in the relevant art will understand that a web site may also act as a web portal. A web portal is a web site that provides a variety of services to users via a collection of web sites or web based applications.

As those of ordinary skill in the art would understand, the internet is a global computer network which comprises a vast number of computers and computer networks which are interconnected through communication links. A person skilled in the relevant art will understand that an electronic communications network of the present invention, may include, but is not limited to, one or more of the following: a local area network, a wide area network, an intranet, or the Internet. The interconnected computers exchange information using various services, including, but not limited to, electronic mail, Gopher, web-services, application programming interface (API), File Transfer Protocol (FTP) This network allows a server computer system (a Web server) to send graphical Web pages of information to a remote client computer system. The remote client computer system can then display the Web pages via its web browser. Each Web page (or link) of the WWW is uniquely identifiable by a Uniform Resource Locator (URL). To view a specific Web page, a client computer system specifies the URL for that Web page in a request (e.g., a HyperText Transfer Protocol (“HTTP”) request). The request is forwarded to the Web server that supports the Web page. When the Web server receives the request, it sends the Web page to the client computer system. When the client computer system receives the Web page, it typically displays the Web page using a browser. A web browser or a browser is a special-purpose application program that effects the requesting of web pages and the displaying of web pages and the use of web-based applications. Commercially available browsers include Microsoft Internet Explorer and Firefox, Google Chrome among others. It will be understood that with embodiments of the present invention, any browser would be suitable.

Web pages are typically defined using HyperText Markup Language (“HTML”). HTML provides a standard set of tags that define how a Web page is to be displayed. It will be understood that other languages, all well known in the art, may be used with the embodiment of the present invention. When a user indicates to the browser to display a Web page, the browser sends a request to the server computer system to transfer to the client computer system an HTML or other language document that defines the Web page. When the requested HTML document is received by the client computer system, the browser displays the Web page as defined by the HTML document. The HTML or other language document contains various tags that control the displaying of text, graphics, controls, and other features. The HTML document may contain URLs of other Web pages available on that server computer system or other server computer systems.

A person skilled in the relevant art will understand a web-based application refers to any program that is accessed over a network connection using HTTP, rather than existing within a device's memory. Web-based applications often run inside a web browser or web portal. Web-based applications also may be client-based, where a small part of the program is downloaded to a user's desktop, but processing is done over the Internet on an external server. Web-based applications may also be dedicated programs installed on an internet-ready device, such as a smart phone.

A person skilled in the relevant art would understand the term “service provider” to refer to any person or company that provides organizations and businesses with services, including, but not limited to, consulting, legal, real estate, education, communications, storage, processing, construction, medical health, and many other services.

It will be understood by a person skilled in the relevant art that the term “audit” or “auditing” shall refer to a review, inspection or evaluation of a claim for reimbursement. Audits are typically performed by a carrier/payor, such as, for example, an insurance policy issuer or a benefit plan provider. In a preferred embodiment of the present invention, an audit may be performed after a claim has been identified for such a review by an adjudication process, including an automated online adjudication process of the present invention. As used herein, a person skilled in the relevant art will understand that the term “adjudication” or “adjudicating” to refer to a pre-audit process of reviewing and determining whether a claim should be reimbursed or, alternatively, whether the claim should be targeted for further review after comparing the claim to the benefit, eligibility or coverage requirements as well as predefined verification criteria. In a preferred embodiment, this can be done electronically. The online adjudication process consists of receiving the electronic claim from an insured person, member or user and then utilizing software to process the claim and make a decision whether the electronic claim should be subject to further review or audit.

In the following specification, it will be understood by a person skilled in the relevant art that the term “member”, “user” or “beneficiary” refers to a person (or that person's agent) who makes use of the online submission process and the term “user” shall refer to a user of the system recited herein. In some cases, the user is a member of a group (e.g. employee) with known benefits as part of that membership (e.g. one or more employee benefit programs), hence the reference to “member”. It will be further understood that employee benefit programs may be human resource programs, defined contribution programs, defined benefits programs, workplace savings programs, medical savings programs, or payroll programs. In another embodiment, the member may be a beneficiary of an insurance policy. In yet a further embodiment, a user/member may also refer to those who are submitting such claims for reimbursement on behalf of or for the ultimate policy holder, program member or beneficiary. For example, an insurance claims adjustor (e.g. one who investigates insurance claims or claims for damages and recommends an effective settlement) may make a claim for reimbursement or payment of a loss on behalf of an insurance policy holder when there has been a property loss. In such a circumstance the claims adjustor may be referred to as the user as the adjustor may be submitting the claim submission for reimbursement to the carrier/payor. In such circumstances, the carrier/payor may reimburse or pay the policy holder directly and not the adjustor, but, in some cases, may reimburse or pay the adjustor directly.

A person skilled in the relevant art will also understand that the term “claim” refers to a request or demand for payment of a cost incurred or a reimbursement of a payment made, wherein the cost incurred or reimbursement may be in accordance with a policy, plan or other informal or formal arrangement, such as, for example, an employee benefit program, insurance policy, etc. For example, a member/user, including a third party submitting the claim on behalf of a user/member (i.e. adjustor) can submit a claim for reimbursement of an expense. In a preferred embodiment, the user/member (e.g. the entity incurring the expense) may be requesting that a cost incurred by paid by a third party. The embodiments of the present invention can support transactions for any type of claim. In a preferred embodiment, the present invention can support transactions from, but not limited to, claims relating to medical insurance, employee benefit programs, royalty payments, life insurance, property, and causality. For example, embodiments of the present invention may include claims directed to specific policies for health insurance, home owners insurance, third party liability, workers compensation and employee or workers benefits. The term “claim” may also refer to a request or demand for payment of a benefit. It will be understood in the present invention that the term “benefit” shall refer to the amount of money or other consideration, compensation, etc., a member/user may receive under circumstances, conditions, etc. established by a specific policy or plan (e.g. annuities, insurance, government programs, health insurance, home owners insurance, third party liability, workers compensation and workers benefits). Benefits may take the form of one time payments for services or wares rendered or periodic payments members/users may begin to receive following certain events (e.g. retirement), but may also refer to social assistance payments, such as, for example, welfare payments, rental assistance, food stamps, etc. In general, benefits may be fixed at a certain amount (often determined by the amount users/members have contributed in premiums or taxes) or may vary according to other factors, (e.g. inflation or an underlying investment).

In the following specification, the term “proof of expense” or “POE” shall refer to a receipt or other proof of payment, typically made by a member/user. The term “proof of loss” or “POL” shall refer to evidence supporting a claimed loss experienced by a member/user. It will be understood by a person skilled in the relevant art that the term “expense” or “loss” as provided herein can refer to any claim or item that is to be reimbursed to a user.

It will be understood by a person skilled in the relevant art that the term “carrier” shall refer to an insurance organization, underwriting organization, benefit plan provider or third-party service provider. It will also be understood by a person skilled in the art that the “carrier” may also be referred to as the “payor”, as the carrier/payor is an entity responsible for the reimbursement and which must be satisfied that the conditions for the reimbursement or payment of a claim have been met. In some cases, an insured or other risk maybe spread between multiple carriers/payors involved with claims reimbursement process.

It will be understood by a person skilled in the relevant art that the term “mobile device” or “portable device” refers to any portable electronic device that can be used to access a computer network such as, for example, the internet. Typically a portable electronic device comprises a display screen, at least one input/output device, a processor, memory, a power module and a tactile man-machine interface as well as other components that are common to portable electronic devices individuals or members carry with them on a daily basis. Examples of portable devices suitable for use with the present invention include, but are not limited to, smart phones, cell phones, wireless data/email devices, tablets, PDAs and MP3 players.

It will be understood by a person skilled in the relevant art that the term “network ready device” or “internet ready device” refers to devices that are capable of connecting to and accessing a computer network, such as, for example, the internet. A network ready device may assess the computer network through well-known methods, including, for example, a web-browser. Examples of internet-ready devices include, but are not limited to, mobile devices (including smart-phones, tables, PDAs, etc.), gaming consoles, and smart-TVs. It will be understood by a person skilled in the relevant art that embodiment of the present invention may be expanded to include applications for use on a network ready device (e.g. cellphone). In a preferred embodiment, the network ready device version of the adjudication software may have a similar look and feel as a browser version but that is optimized to the device. The application may increase the ease of use when accessing online claims submission which may include the ability to access the camera within the mobile phone to upload receipts.

In a preferred embodiment, the grading system, OCR scraping, and adjudication rules functionality may also be made available on a stand-alone basis where carriers/payors have an existing claim submission software but may wish to incorporated the adjudication functionalities either as a standalone functionality or as part of an existing software solution.

It will be further understood by a person skilled in the relevant art that the term “downloading” refers to receiving datum or data to a local system (e.g. mobile device) from a remote system (e.g. a carrier/payor server or client) or to initiate such a datum or data transfer. Examples of a remote systems or clients from which a download might be performed include, but are not limited to, web servers, FTP servers, email servers, or other similar systems. A download can mean either any file that is offered for downloading or that has been downloaded, or the process of receiving such a file. A person skilled in the relevant art will understand the inverse operation, namely sending of data from a local system (e.g. mobile device) to a remote system (e.g. a carrier/payor server) is referred to as “uploading”.

Embodiments of the present invention may reduce the need for manual intervention in the review and/or adjudicating of an electronic or online claim submission. By introducing an online and automatic electronic adjudication processes and systems for grading submissions based on customizable criteria, carriers/payors can identify, determine and assess risks associated with claims submitted electronically. The adjudication processes and systems of the present invention can involve a process for authenticating data submitted and then grading the data submitted to determine if it meets the necessary criteria. This can be done in a standalone manner (e.g. part of separate software solution) or integrated with existing software of a carrier/payor. The customizable criteria can be based on and determined by a number of factors, including but not limited to, the name and specifics of the claim to be submitted but are determined by the carrier/payor prior to the submission of any claim. The customizable criteria may comprise specific categories or types of data to be submitted as well as predetermined values to be attached to each category or type of data submitted (e.g. weighted data or grading criteria). The authentication of the predetermined type of data and the adjudication thereof based on the pre-weighted grading criteria as provided by a carrier/payor can be used to identify claims that pose a risk of being inadvertently entered incorrectly. On this basis, an error assessment of the claim can be determined and reported to the carrier/payor. Claims submitted which do not meet the criteria established for the authentication and adjudication can be identified as higher risk claims to be audited thereby improving efficiency and accuracy of online claim submissions.

In one embodiment of the present invention, data may be lifted when scraping POL/POE documentation (e.g. a receipt), which can then be compared to the information submitted directly by the member/user/beneficiary in order to authenticate the data submitted. Once the data has been authenticated, the data can be adjudicated by comparing and grading the submitted data against predetermined categories of data and pre-weighted grading criteria to arrive an assessment of whether further steps are required (i.e. the carrier needs to conduct an audit) or the member/user can be reimbursed or paid for the claimed amount. In a further preferred embodiment, the authentication and adjudication processes are conducted external to the carrier/payor systems (e.g. on a server outside of or not connected to a carrier/payor's servers). In yet another preferred embodiment, the claim can be recorded in a payor's online submission tool located on a network ready device, while the authentication and adjudication processes are conducted on a separate server system.

Elements of the present invention may be implemented with computer systems which are well known in the art. Generally speaking, computers include a central processor, system memory, and a system bus that couples various system components including the system memory to the central processor. A system bus may be any of several types of bus structures including a memory bus or memory controller, a peripheral bus, and a local bus using any of a variety of bus architectures. The structure of a system memory is well known to those skilled in the art and may include a basic input/output system (BIOS) stored in a read only memory (ROM) and one or more program modules such as operating systems, application programs and program data stored in random access memory (RAM). Computers may also include a variety of interface units and drives for reading and writing data. A user or member can interact with computer with a variety of input devices, all of which are known to a person skilled in the relevant art.

One skilled in the relevant art would appreciate that the device connections mentioned herein are for illustration purposes only and that any number of possible configurations and selection of peripheral devices could be coupled to the computer system.

Computers can operate in a networked environment using logical connections to one or more remote computers or other devices, such as a server, a router, a network personal computer, a peer device or other common network node, a wireless telephone or wireless personal digital assistant. The computer of the present invention may include a network interface that couples the system bus to a local area network (LAN). Networking environments are commonplace in offices, enterprise-wide computer networks and home computer systems. A wide area network (WAN), such as the Internet, can also be accessed by the computer or mobile device.

It will be appreciated that the type of connections contemplated herein are exemplary and other ways of establishing a communications link between computers. Mobile devices and networks can be used. The existence of any of various well-known protocols, such as TCP/IP, Frame Relay, Ethernet, FTP, HTTP and the like, is presumed, and computer can be operated in a client-server configuration to permit a user to retrieve and send data to and from a web-based server. Furthermore, any of various conventional web browsers can be used to display and manipulate data in association with a web based application.

The operation of the network ready device (i.e. a mobile device) may be controlled by a variety of different program modules. Examples of program modules are routines, programs, objects, components, data structures, etc. that perform particular tasks or implement particular abstract data types. It will be understood that the present invention may also be practiced with other computer system configurations, including multiprocessor systems, microprocessor-based or programmable consumer electronics, network PCS, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices.

The operation of the present invention is based on the pre-existence of some kind of agreement whereby certain expenses, losses, benefits, etc. shall be paid or reimbursed to a user/member. In a preferred embodiment, the agreement whereby the expense, loss, benefit, etc. can be paid or reimbursed may arise in the context of benefit plan. In yet another preferred embodiment, the expense, loss, benefit, etc. can be paid or reimbursed may arise in the context of a master insurance policy and accompanying schedule of benefits. It will be understood that any agreement as to a particular payment or reimbursement can be accommodated by the present invention.

Embodiments of the present invention can be implemented by a software program for processing data through a computer system. It will be understood by a person skilled in the relevant art that the computer system can be a personal computer, mobile device, notebook computer, server computer, mainframe, networked computer (e.g., router), workstation, and the like. The program or its corresponding hardware implementation is operable for providing online verification of claim submissions. In one embodiment, the computer system includes a processor coupled to a bus and memory storage coupled to the bus. The memory storage can be volatile or non-volatile (i.e. transitory or non-transitory) and can include removable storage media. The computer can also include a display, provision for data input and output, etc. as will be understood by a person skilled in the relevant art.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It will be understood that in establishing a user interface, a task bar may be preferably positioned at the top of a screen to provide a user interface. Preferably, a textual representation of a task's name is presented in this user interface, preferably as a button, and the task names may be shortened as necessary if display space of the button is constrained. The labelled button having the task's name preferably operate as a type of hyperlink, whereby the user/viewer can immediately switch to the activity, view, etc. of an each of the tasks by selecting the button containing the applicable name from the task bar. In other words, the user or viewer is redirected by the application to that the function represented by the task button by selecting the labelled hyperlink. Preferably, the task entry associated with the currently-displayed work unit view may be shown in a different graphical representation (e.g., using a different color, font, or highlighting). In preferred embodiments, there may be provided a display having a selectable “X” in the task bar entry for each task: if the user clicks on the “X”, then its associated task may be ended and the view of its work unit may be removed. A user interface may be web-based, application based, or a combination.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “creating,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### Setting Authentication and Adjudication Criteria

Prior to allowing members or users to make an online claim submission, a preferred embodiment of the present invention provides for the payor establishing the criteria by which a claim can be reviewed and assessed (see FIG. 1 at 100). By establishing the customizable criteria, the payor or carrier can determine under what circumstances or conditions the request for payment will be assessed and whether payment is warranted or further action (i.e. an audit) is required. The customizable criteria can be based on and determined by a number of factors, including but not limited to, the name and specifics of the claim to be submitted, but are determined by the carrier/payor prior to the submission of any claim. In a preferred embodiment, the customizable criteria may comprise at least one of the following: (a) specific categories or types of data to be submitted; (b) predetermined values (e.g. alphanumeric characters) to be attached to each category or type of data submitted; and (c) predetermined or predefined verification data (e.g. weighted data or grading criteria). The authentication of the user submitted data and the adjudication thereof based on the pre-weighted grading criteria according to adjudication rules as provided by a carrier/payor can be used to identify claims that pose a risk of containing an error whether inadvertently entered or otherwise. These claims may then need to be targeted for further follow-up including, but not limited to, an audit. In a preferred embodiment, claims submitted which do not meet the customizable and payor determined criteria established for authentication and adjudication can be identified as high risk claims to be audited thereby improving efficiency and accuracy of online claim submissions. On this basis, an assessment of the accuracy of the claim can be determined and reported to the carrier/payor.

In a preferred embodiment, payors may have the ability to manage online claim submission requirements by creating a template which may contain the input criteria and adjudication rules that may be used during the submission, authentication and adjudication of the claim online. In a preferred embodiment, these may include, for example, the adjudicating rules in place during submission, the procedures eligible to be adjudicated through online submission, and whether uploading a proof of expense is required along with the submission.

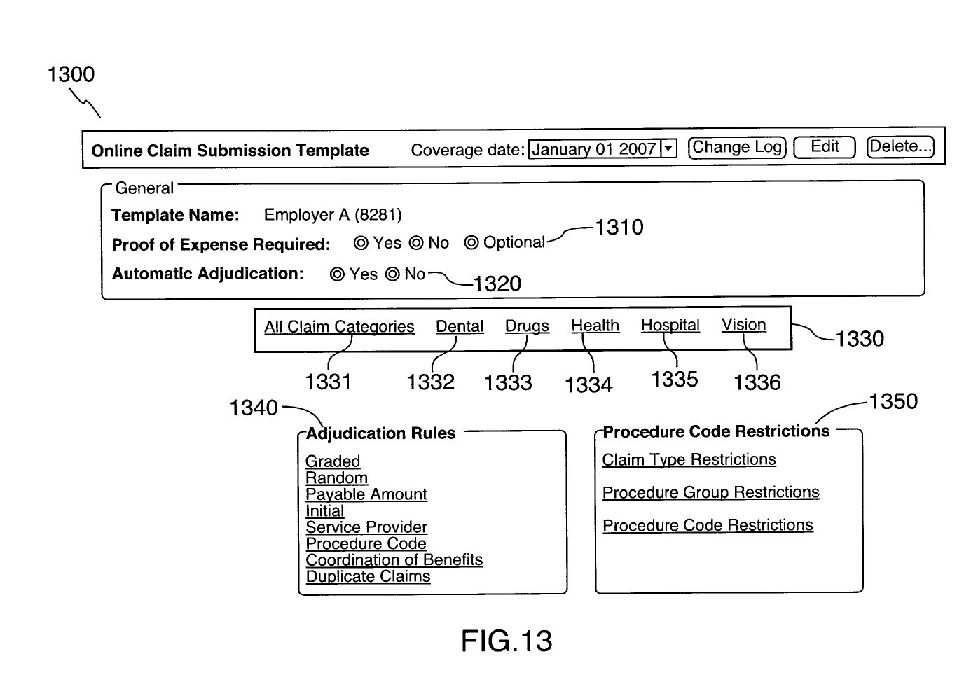

As shown in FIG. 13, the templates may be broken down into the following sections where payors/carriers can attach restrictions or other criteria to be enforced during online claims submission. These include, but are not limited to, Proof of Expense Requirement 1310 (e.g. whether uploading a POE/POL is required). It will be understood by a person skilled in the relevant art that one or several possibly responses could be allowed including, but not limited to “YES”, “NO”, or “OPTIONAL (see FIG. 13). In a preferred embodiment, there may also be provided a selection for automatic adjudication 1320, which may include, in a preferred embodiment, a real-time representation of the adjudication result. In a preferred embodiment, selections may consist of YES and NO whereby the selection of NO may provide a claim confirmation response but no expected payable details. As shown in FIG. 13, there is also provided adjudication rules 1340 and procedure code restrictions 1350. Adjudication rules may determine which rules are in force for a specific template, for example, a graded adjudication. Procedure code restrictions may indicate which procedure codes are eligible to be submitted electronically online. For example, the carrier may allow for vision claims to be submitted online electronically, but hospital claims are not eligible for submission. In a preferred embodiment, adjudication rules 1340 may comprise a list of types of adjudication available including graded adjudication, random adjudication, payable amount adjudication, initial adjudication, service provider adjudication, procedure code adjudication, coordination of benefits adjudication, and duplicate claims adjudication. In a preferred embodiment, procedure code restrictions 1350 may comprise claim types, procedure groups, and procedure codes.

Adjudication rules may be broken down into categories based on the type of adjudication performed. Types of adjudications available include those set out in FIG. 13. Payors can select whether or not an adjudication applies, and which adjudication categories are in place. It will be understood that specific adjudication procedures can be used in combination to allow for the level of control each carrier or payor would like to enforce.

As noted above, payors, when configuring a template, may need to apply settings for procedure code restrictions 1350 and adjudication rules 1340. As shown in FIG. 13, an iframe 1330 may appear that may have one of more of the follow selection options that may be available to customize, including, “All Claim Categories” 1331, “Dental Expense” 1332, “Drug Expense” 1333, “Health Expense” 1334, “Hospital Expense” 1335, and “Vision Expense” 1336. When “All Claim Categories” 1331 is selected, payors may be able to configure settings on all claim categories should they want the same settings applied to all types of claim without having to set each claim category individually. In a preferred embodiment, the list of possible settings may include “Random Adjudication”, “Payable Amount Adjudication”, “Initial Adjudication”, “Service Provider Adjudication”, “Procedure Code Adjudication”, “Coordination of Benefits Adjudication” or “Duplicate Claims Adjudication” as categories to configure.

Payors/carriers may also place restrictions on procedure codes available to view during online claims submission. Restrictions can be placed on entire claim types and procedure groups, or specific procedure codes. This may allow flexibility to ensure claims submitted online are for acceptable procedure codes. Payors can, for example, navigate between claim type, procedure group and procedure codes to indicate which procedure codes are allowable. Procedures that are not allowable may not be visible during online claims submission under the procedure code section. Only procedures that are allowable may appear in the procedure code field visible to members during the online claims submission process.

Random Adjudications can be set by payors randomly assigning claims for Adjudication. Random Adjudications are based on the entire claim submitted and are based on the partner's entire block. For example, payors may set the random adjudication value as 20 claims. In this scenario, 1 out of every 20 claims would randomly be placed in the adjudication or audit queue. An adjudication based on the payable amount may allow users to identify claims submitted that exceed the allowable amount on either the procedure code, or the entire claim. Users may have the ability to set a maximum allowable procedure total, and maximum allowable claim total. Based on the submitted amount, claims may go into the adjudication or audit queue when they exceed the allowable values set. An initial adjudication may automatically place the first claim submitted by a member into adjudication. Regardless of other adjudication categories which may be in force, when an initial adjudication is enforced the first electronically submitted claim would automatically be placed in adjudication. This is useful when assessing the validity of claims for members attempting for their first time. Service provider adjudications can be used to flag service providers which may be of risk or have had fraudulent experience in the past. By adding provider records to the service provider adjudications section, anytime a claim is received by a service provider it may automatically go into adjudication. When a claim is received through Online Claims Submission and it includes a procedure code that has been set as triggered a procedure code adjudication, the entire claim may be pended with the procedure code triggering the adjudication being placed in the adjudication or audit queue. This feature may allow users to identify either high cost procedures, or high risk procedures for fraud which may be audited before they are paid. Coordination of benefits adjudication may place claims with coordination of benefits involved into the adjudication or audit queue. This is useful to ensure clients that have alternate insurance coverage are properly submitting claims with coordination with primary insurance coverage. When a claim is received and users have coordination of benefits in place, claims may be placed in the adjudication or audit queue to be reviewed. When claims are submitted and rejected due to a duplicate claim being found in the claims experience, it may be placed into the adjudication or queue.

This functionality may be useful for those payors who are attempting to submit duplicate claims, or may need further training and assistance using online claims submission embodiments of the present invention. If this functionality is enabled, the entire claim may be pended with the duplicate procedure code going into the adjudication or audit queue.

As adjudication rules 1340 and procedure code restrictions 1350 can be specific to a claim category, payors may need to select a claim category to attach restrictions 1350 or configure adjudication rules 1340. Within the template screen 1300, for example, payors may select a claim from the claim category iframe 1330, and may see the options available to configure that specific claim by category. By making this as flexible as possible, payors can be able to set adjudication requirements unique to a claim category, and also apply procedure code restrictions by claim category. When navigating through the available claim categories, viewers may, for example, have the option to expand on an area using iframes. For example, a viewer may select a Dental Claim category (1332 in FIG. 13) and may be presented with configuration options. When selecting an item, an iframe may appear showing the detailed maintenance screen where viewers can apply the settings in place. In a preferred embodiment, viewers may be able to select multiple adjudication types to be enforced.

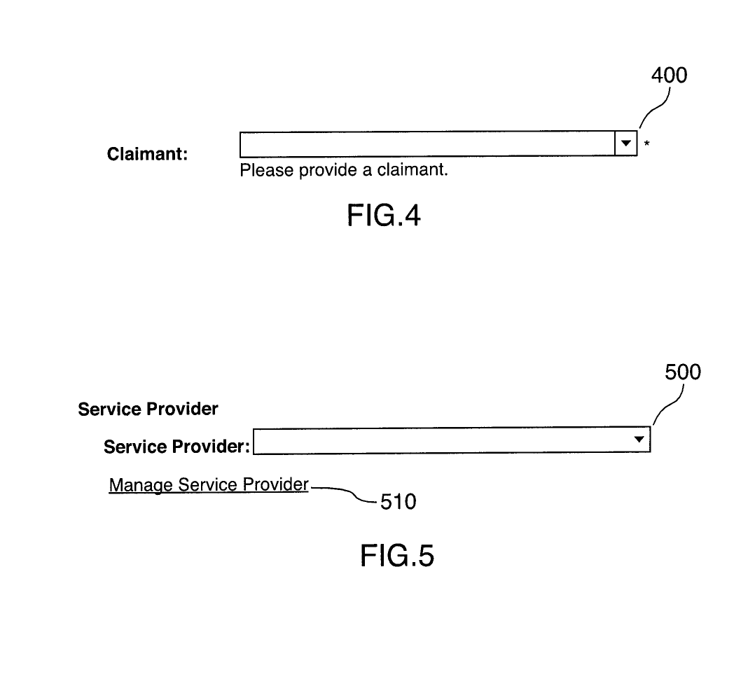

The authentication and adjudication method of the present invention may first involve the payor or carrier identifying one or more input criteria selected from a number of possible variables which then may be weighted in order to grade the need for possible follow-up (e.g. audit) for a given submission (e.g. that a specific submission should be targeted for further action, which can include, for example, an audit). These input criteria could include a series of questions requiring input from the person submitting the claim (e.g. the user or claimant), such as, for example, name of the user, insurance or other benefit provider, type of claim and date of procedure requiring the claim. The information that may be submitted at this time can be related to the identity of the user (see 400 in FIG. 4), which can be referred to as a unique ID, or the specifics of the particular claim that is being made, which can be collectively referred to as claim information. It will be understood by a person skilled in the relevant art that the input criteria may vary depending on the nature of the user, claim, benefit plan, master policy, coverage agreement, etc.

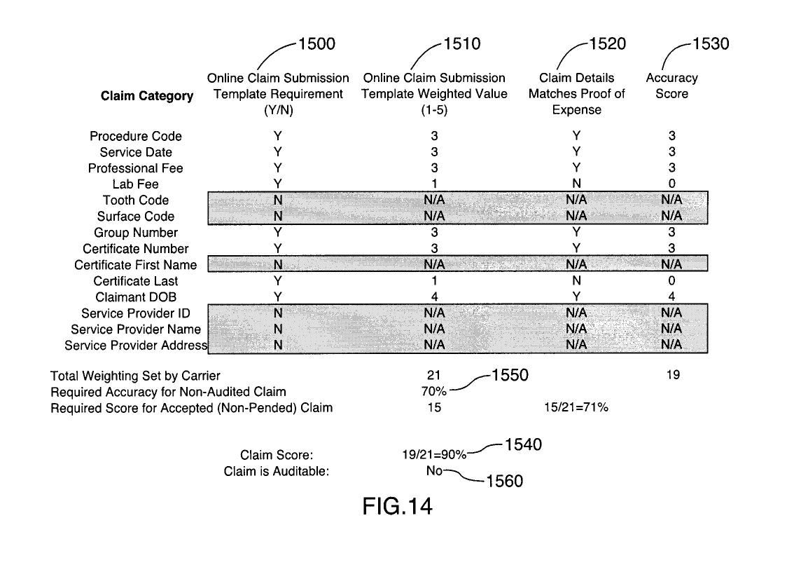

The authentication and adjudication method of the present invention may also involve the payor or carrier identifying one or more verification criteria selected from a number of possible variables which then may be weighted in order to grade the need for possible follow-up or potential audit for a given submission (e.g. that a specific submission should be targeted for further action, which can include, for example, an audit). These verification criteria could include a series of alphanumeric or numeric values that can be assigned to specific input criteria (see online submission template weighted value in FIG. 14). The verification criteria may be weighted; input criteria that are deemed more significant by the payor can be granted a higher numeric value. Those input criteria that are correctly answered can be “weighted” by having a greater numeric value (See FIG. 14). It will be understood by a person skilled in the relevant art that the verification criteria may vary depending on the nature of the user, claim, benefit plan, master policy, coverage agreement, etc.

The assessment of the input criteria may simply be a binary system (i.e. yes/no, correct/incorrect, etc.) or may be a weighted system whereby the input criteria is compared with the verification criteria. Once the inputs are provided by the user or the member, the criteria can be assessed either by the binary assessment or the weighted assessment tools (See FIG. 14). In a preferred embodiment, the assessment or adjudication of the input criteria may be accomplished by comparing the input criteria with the verification criteria; if the input criteria match the verification criteria, the numeric value of the verification criteria is added to an “adjudication” score or value. This can then repeated for multiple input criteria to arrive a total adjudication score or value. If the adjudication score meets or exceeds a predetermine level or threshold as set by the payor or carrier, the input data is assumed to be accurate and may not be flagged for further review. In that case, the claim may then be paid by the payor/carrier to the member/user. If the adjudication score does not meet or exceed the predetermined level, the claim may be flagged for further review, including an audit. The procedures which govern the adjudication process using the input criteria and the verification criteria may collectively be referred to as “adjudication rules”.

A person skilled in the art will understand that various criteria do not need to be identical in order to be considered to match. It will be understood that there are a number of ways to assess whether the input criteria (which, in a preferred embodiment, can consist of any alphanumeric/numeric input or string thereof) matches the verification criteria.

A preferred embodiment of the present invention is seen in FIG. 14. As seen in FIG. 14, the weighted system shows a series of categories of that can be inputted by the user. This can include any acceptable criteria that need to be reviewed or assessed. Carriers/Payors may configure the requirements to be considered when assessing or adjudicating a claim submitted online, for example, whether the claim category is included in the assessment (e.g. is provided in a template), as shown as 1500 on FIG. 14. If a carrier/payor includes a claim category when assessing a claim submitted online, an importance or weighted value for the claim category is established, as shown as 1510 in FIG. 14. When a claim is submitted online, and the user/member inputs the claim details and uploads the “POE/POL” for data lifting/scraping. The claim categories to be included in the assessment, defined by the carrier/payor, are then compared to the data lifted or scraped from the “POE/POL” and matching values are identified, as shown as 1520 on FIG. 14. In the embodiment provided in FIG. 14, matching values (between the claim details submitted by the member/user and the values lifted from the “POE/POL”) receive a score, based on the importance value of the claim category, as defined by the carrier/payor, as shown as 1530 on FIG. 14. The importance value scores for each claim category identified as a matching value are totalled, and compared against the overall total available score if each claim category received a matching value and a full score, for example, a claim receiving an accuracy score of 19 out of 21, or 90% accuracy, as shown as 1540 on FIG. 14. Carriers/payors may assign a required accuracy level, for example, a percentage that may need to be achieved for a claim submitted online to receive a passing grade. Claims submissions that do not receive a passing grade, will be identified for further review, for example, an audit by the carrier/payor. For example, the carrier may establish a required score of 70% for a claim submission to receive a passing grade, as shown as 1550 on FIG. 14. Claims submitted that receive a score of 70% accuracy, or higher would not be identified for further review, while claim submissions that do not meet the 70% accuracy threshold would be identified for further review, such as, an audit, as shown as 160 on FIG. 14.

In a preferred embodiment, a graded adjudication involves scraping/OCR technology to scrape a receipt to extract claim information and compare the matching fields found on the receipt versus the details inputted for the claim.

In a preferred embodiment, graded or weighted adjudication involve at least one claim type category to ensure payors can place importance on submission fields based on the type of claim being submitted. In a preferred embodiment, claim type categories may include: (a) Dental Expense; (b) Drug Expense; (c) Health Expense; (d) Hospital Expense; and (e) Vision Expense. Within each claim type, payors/carriers can determine the importance of fields found on standard POL/POE documents to determine the accuracy of the claim. During the adjudication process, the information scraped from the POE may be compared to the details inputted by the user when the claim was submitted (referred to as “authentication”). Following authentication, matching fields may be counted, and the weighting of importance may determine the final score of the claim (see FIG. 14).

As shown in FIG. 14, carriers/payors may select a percentage threshold of accuracy that may be used to establish whether a claim is rated with enough risk to be audited. For example, a percentage threshold of 70% would mean a claim must meet 70% accuracy relevant to the values set on individual elements of claim details. Importance values are placed on items commonly found on POEs/POLs or otherwise inputted by the payor, such as dates, names, dollar amounts, and other claim details. Importance rankings may be based on a scale of 1 to 5, with 5 being the highest importance; for example, the scale would resemble the following: 1—Very Low; 2—Low; 3—Medium; 4—High; 5—Very High.

During adjudication, the scores may be totalled to determine an adjudication score or value. As set out in FIG. 14, there is provided an example where a payor places importance values on a number of different categories. In the preferred example set out in FIG. 14, a total score of 21 is available. When data from a proof of expense is scraped, all data found on the receipt may be reviewed against the information inputted during the claim. Matching results found on both the claim details submitted and the proof of expense may allocate points equal to the value of that response (e.g. the importance value). As show in FIG. 14, an example of the matching information on the claim details submitted is provided. As shown in FIG. 14, the total score total 19 out of 21, or 90% was determined. This claim would not be adjudicated as the graded adjudication rule requires an accuracy of greater than 70% (15 out of 21). Claims that do not meet the minimum accuracy level for a graded adjudication may be treated as pending claims and go into the adjudication or audit queue.

Once the input criteria and the verification criteria have been established, a system can be set up to allow the users/members to seek reimbursement of the claims using online claim access. This typically starts with a user requesting reimbursement or payment of a claim, which, in a preferred embodiment, may be one of several well-known and established types of expenses, losses or benefits. It will be understood, however, that other types of payments, such as, for example, pursuant to a benefit plan, master insurance policy etc. may also be made. Using the online system of claim/benefit submission, it will be understood that the order of the steps are less important but that the functionality is present. FIGS. 1, 16 and 17 set out the general process by which the submitted claim can be assessed or adjudicated.

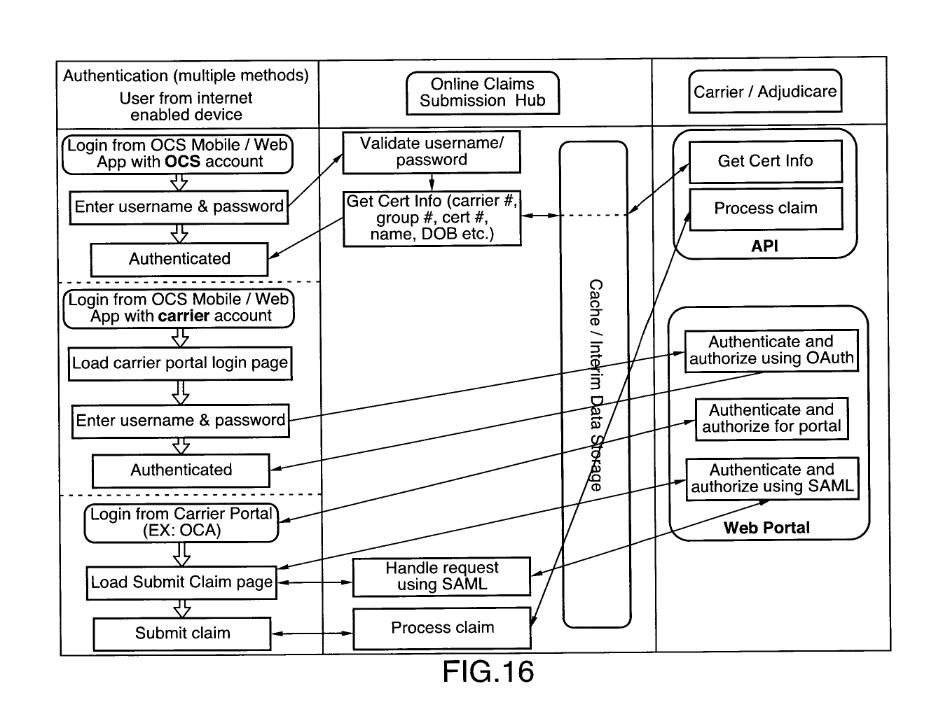

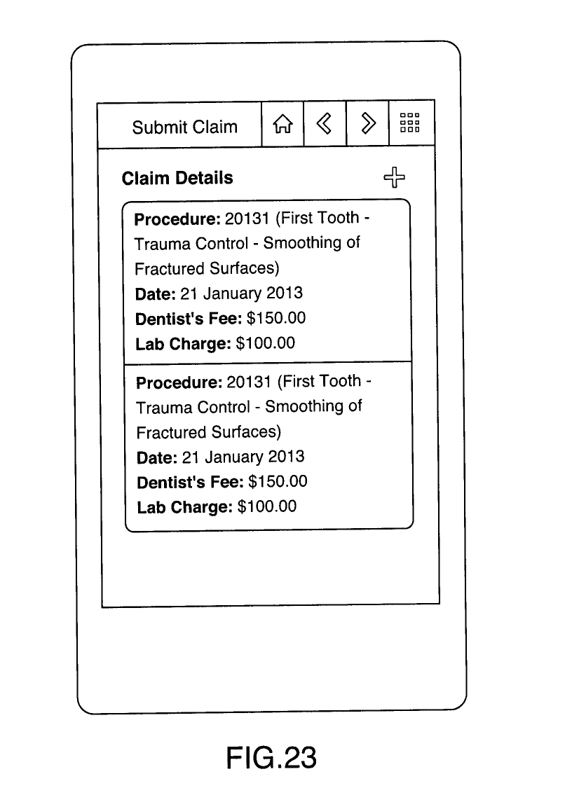

FIG. 16 provides a preferred embodiment of the present invention. The preferred embodiment illustrates, but may not be limited to, the following manners for members/users to interact with an online claims submission system. In this preferred embodiment, there is provided an Online Claims Submission Mobile App (“OCS Mobile App”)—an application that installs and runs on networked devices (see for example, FIGS. 23 to 31). It is used by members/users (also referred to as “certificates” in association with medical or health related claims) to access their plan information, including, for example, group health benefit information and submit one or more claims through their networked device. In a preferred embodiment, there is also provided an Online Claims Submission Mobile Website (“OCS Mobile Web”) which provides a website that enables members/users (or, as in this embodiment, certificates) to access their group health benefit information and submit claims through their networked device without installing an application on their device. In this preferred embodiment, this may also include the OCS Mobile Web to be hosted in a data center or a cloud service. Carriers/payors may require a Uniform (or Universal) Resource Locator (“URL”), which represents the address or location of a web site, web portal, etc. or other web site location identifier and a network connection (e.g. internet) to access the OCS Mobile Website. A preferred embodiment may also include a carrier/payor web portal (“Carrier Portal”). This embodiment provides for a carrier/payor that has an existing website for members/users/certificates to access benefits and claims information may also run OCS Mobile Web within its domain using, in a preferred embodiment, a Single Sign-On solution such as SMAL.

The OCS Mobile Web and Carrier Portal can be considered client (i.e. payor/carrier) side while the Online Claims Submission Hub is the server side that delivers data to and receives data from the mobile app or the mobile website. It acts as the bridge between the user/member/certificate and the carrier/payor (e.g. the insurance carrier system). A response may then be returned back to the member/user/certificate through the bridge. In order for Online Claims Submission Hub and the carrier to communicate, an API can be established and hosted by the carrier at the server side. Both parties should be involved when creating the communication protocol.

As shown in FIG. 16, an authentication method in the diagram illustrates that users would use their user accounts assigned by the Online Claims Submission hub to login to OCS Mobile App or OCS Mobile Web. Such user accounts are also registered through OSC Mobile App or OCS Mobile Web by users/members/certificates that may be required to provide specific user information, including, but not limited to, policy number, identification number and date of birth for registration.

As shown in FIG. 16, there is provided a further authentication method which illustrates that users who have not registered before can use their existing accounts from the Carrier Portal to login to OCS Mobile App or OCS Mobile Web. Authorization methods know in the art, including but not limited to OAUTH or other protocols to allow secure authorization using standard methods from web, mobile and desktop applications, may be used to ensure proper permission is granted to access the member/user/certificate information in the Carrier Portal.

As shown in FIG. 16, there may be provided a further authentication method which illustrates that users who login to the Carrier Portal are not required to login again to submit a claim through Online Claims Submission Hub. A Single Sign-On solution such as SAML (Security Assertion Markup Language) may be used to ensure requests sent to OCS are authenticated.

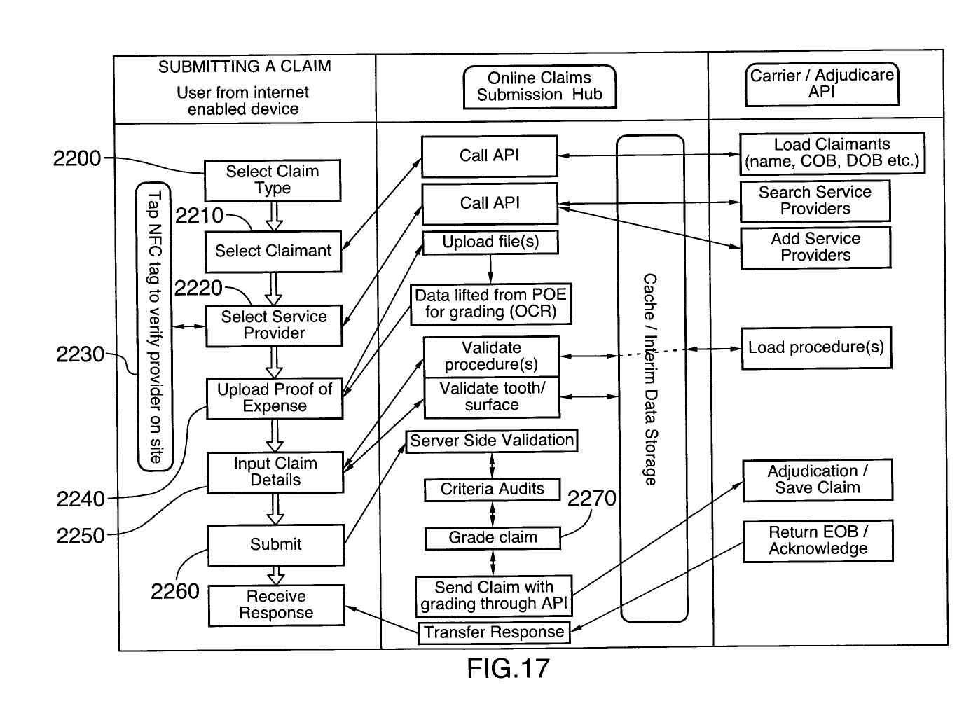

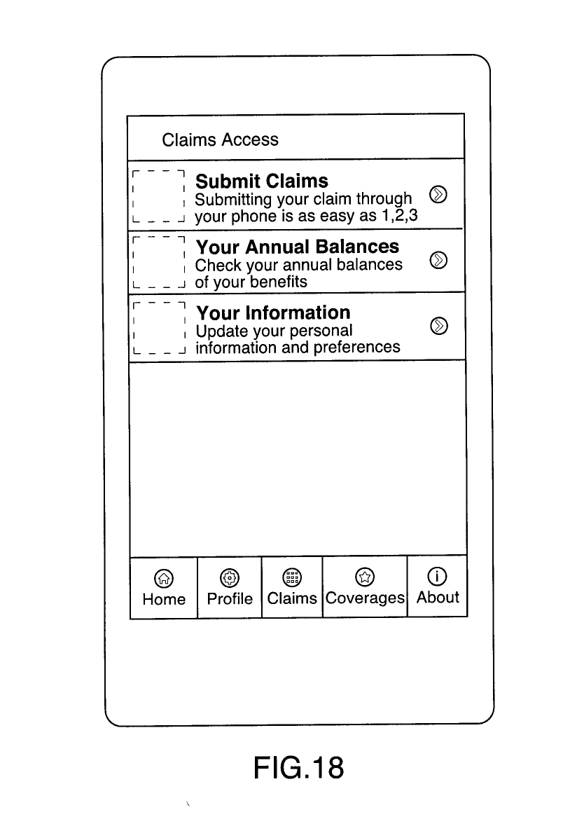

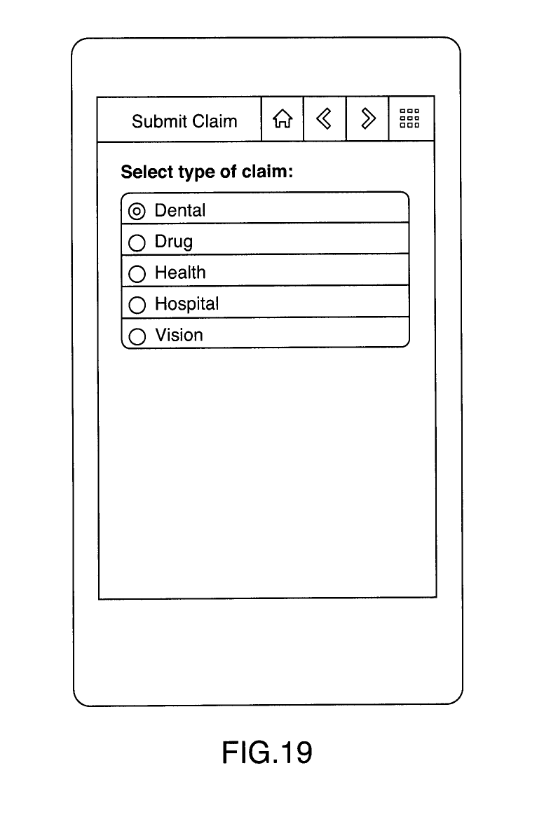

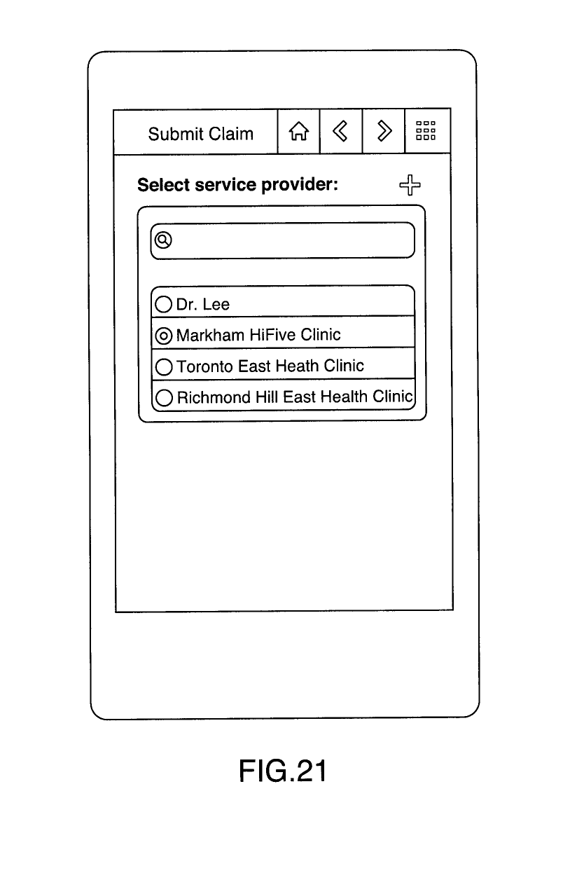

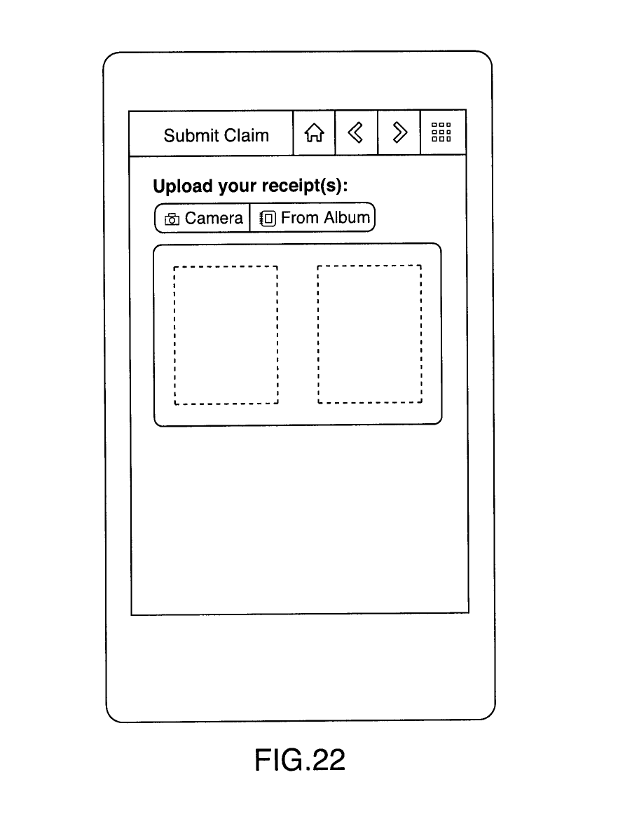

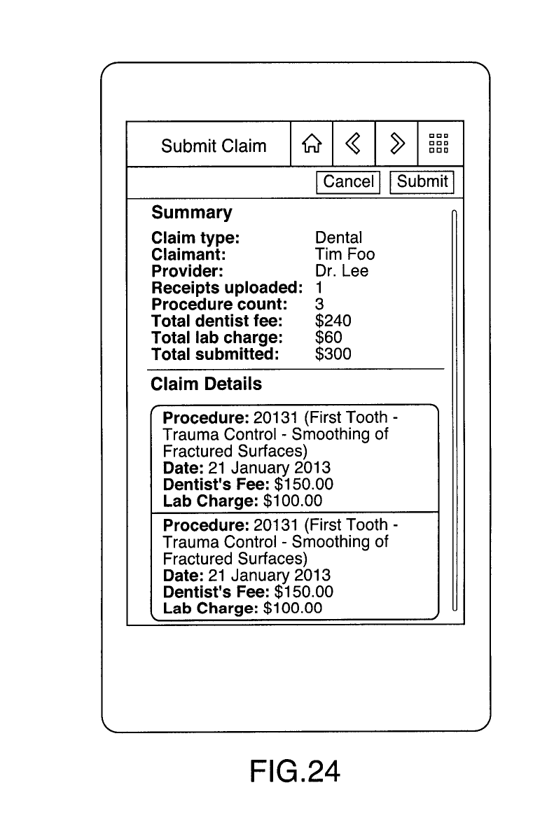

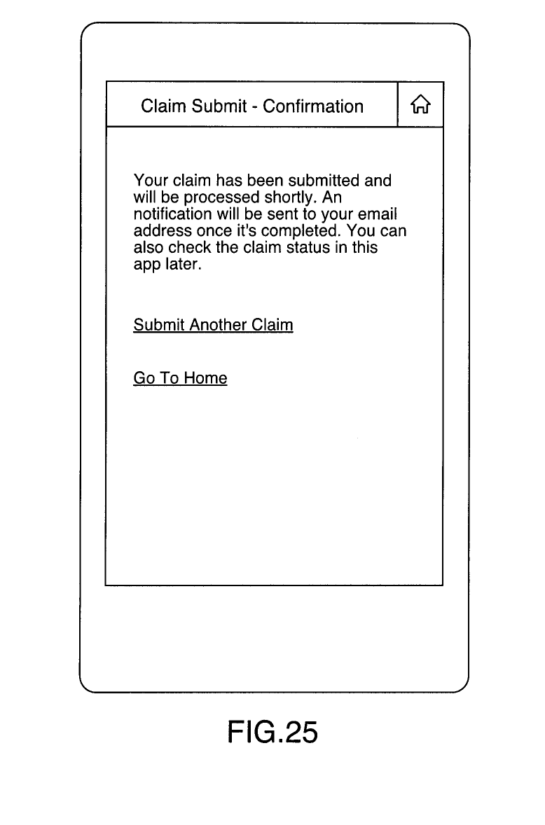

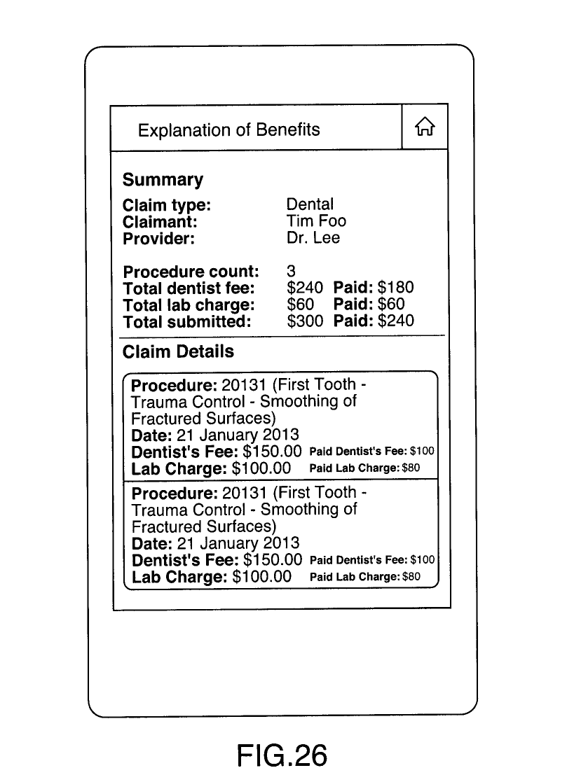

FIG. 17 provides an embodiment for submitting a claim electronically and online. The left most portion of FIG. 17 illustrates the steps for users to submit a claim. The Online Claims Submission Hub runs behind each of these steps to provide and present data to the user interface. It will be understood that the present invention is not limited to the order of the steps of the preferred embodiment as presented. It will be further understood by a person skilled in the relevant art that the order can be varied without departing from the present invention. In a preferred embodiment, a first step provides a list of claim types shown (2200) for user to select (See also FIG. 18). The list varies according to user's preferences and the certificate's benefit plan. A second step may provide a list of eligible claimants (2210) shown for user to select (see also FIG. 19). Claimants' information is retrieved from Carrier System which provides an API for Online Claims Submission Hub to call. A third step provides that the user may then search and specify a service provider (2220) by whom the claimed service was offered. If the device running the submission app supports near field communication (“NFC”), the service provider can tap an NFC tag on the device to confirm their service for on-site submission (2230). Provider information is retrieved from Carrier System which provides an API for Online Claims Submission Hub to call. Step 4 provides that the User may be required to upload a POE/POL (see FIG. 21). In this preferred embodiment, the user can choose to take a photo of the POE/POL or choose an image obtained (e.g. photographed, scanned, etc.) and saved earlier from a folder (See FIG. 22). In order to ensure high quality user experience, the image(s) are asynchronously being uploaded and saved to the Online Claims Submission Hub which starts lifting data from the image(s) using OCR technology without having to wait until the entire claim is submitted. Step 5 provides that while images are being upload, the user can go to next step to enter the claim details (2250; see also FIG. 28). As data is entered, the Online Claims Submission Hub runs different performs the embodiments of the present invention to ensure the inputted data is valid. When all required information is entered (see FIG. 23), a summary is provided to the user for final review (see FIG. 24). The user can decide to submit, cancel or temporarily save the claim 2260 of FIG. 17). If user choose to submit the claim, Online Claims Submissions Hub may go through a few process to provider a response to the user; including, but not limited to, (a) runs a full validation against the data on the server side; (b) compares the inputted data with the data lifted from image(s); (c) runs the adjudication rules against the claim; (d) grade the claim based on the information provided in (b) and (c) (2270 of FIG. 17); (e) send the claim with grading information to a carrier/payor system through an API. The carrier/payor may then decide whether it should subject the claim to further review (e.g. audit the claim), whether it should return the explanation of benefits right way or just simply tell the user that the claim has been received and is under review (See FIGS. 25); and (1) receive response from Carrier System and then send back to the user (See FIG. 26).

As noted above, it begins with the establishment of the input and verification criteria 100 (See FIG. 1). The member/user can then submit a unique ID alone or with the claim information relating to a particular claim 110 in FIG. 1. This can collectively be referred to as the authentication data. As shown in FIG. 1 as a preferred embodiment, the authentication data (e.g. the unique ID and claim information) can be submitted together 120. In a preferred embodiment, the authentication data can be confirmed or authenticated against existing records 150 of the payor/carrier. If the authentication data submitted appears to be incomplete or incorrect, the user can be requested to input the missing information or to clarify submitted information 140.

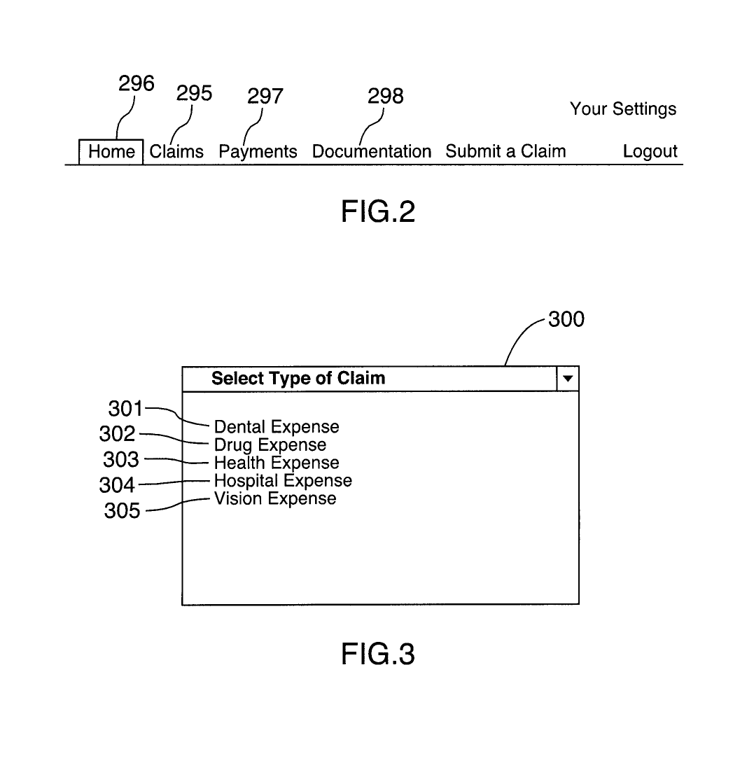

In a preferred embodiment, the user shall identify the nature of the claim or benefit to be reimbursed or paid as part of the authentication data (see 110 of FIG. 1). The input of data necessary for the assessment can be accomplished in a mobile device or on a desk top computer through a drop down menu or task bar within a mobile application or other graphic user interface (see, for example FIGS. 2 through 5). It will be understood that the authentication data can also be provided through a non-graphical interface. It will be understood that in a preferred embodiment, each device may have a graphic user interface (GUI) adapted for use in inputting data in a user friendly manner, man of which are well known in the art.

In a preferred embodiment, the user identifies the type of claim for which reimbursement is being requested (see FIG. 3). For example, if the user has incurred a claim that related to dental work, the user shall indicate that the claim relates to dental work (e.g. a dental expense 301) from drop down menu 300. The drop down menu may provide a list of possible claims including, dental expense 301, drug expense 302, health expense 303, hospital expense 304 and vision expense 305. It will be understood by a person skilled in the relevant art that nature and/or number of possible categories may be dictated by the nature of claim and/or the plan/policy under which such a claim is made.

Following the submission and identification of the unique ID and the claim information (e.g. type of expense/claim), the user/member may, in a preferred embodiment, provide or submit a proof of the expense (“POE”), or proof of loss (“POL”) (see 170 of FIG. 1). In a preferred embodiment, this can represent a scan of a receipt or other proof of payment to a specific service provider or, alternatively, a loss, benefit, etc. The document can be scanned (160) to obtain scanned data that represents the content of the document (e.g. a bitmap image, or text extracted by using an optical character recognition (OCR) technology). The scanned copy of the document may be examined to determine whether the information contained therein can be properly subjected to OCR technology and further processing (e.g. scraping) (see 190 of FIG. 1). If not, the process may be repeated; the user may be requested to rescan the information or manually enter the information (see 200 of FIG. 1). In one embodiment, a camera embedded within a device, or a peripheral device attached to a CPU used to upload a document, or image can be used to upload a scanned copy of the POS/POL. The data contained within the POE/POL (the “scanned data”) can then extracted or scraped for use as described here (210). In a preferred embodiment, the scanned data can then be compared to the data inputted by the member/user separately to determine if the scanned data and the inputted data match (e.g. would be considered to be the same or sufficiently similar within an acceptable margin of error).

Once the input data has been authenticated and compared with the scanned data, the information contained within the input data and the scanned data (collectively the authenticated data) can be subject to the adjudication process by comparison with the verification or comparison data (see 240 of FIG. 1). In a preferred embodiment, the adjudication process may be conducted in the servers of the adjudication service provider (see 250 of FIG. 1).

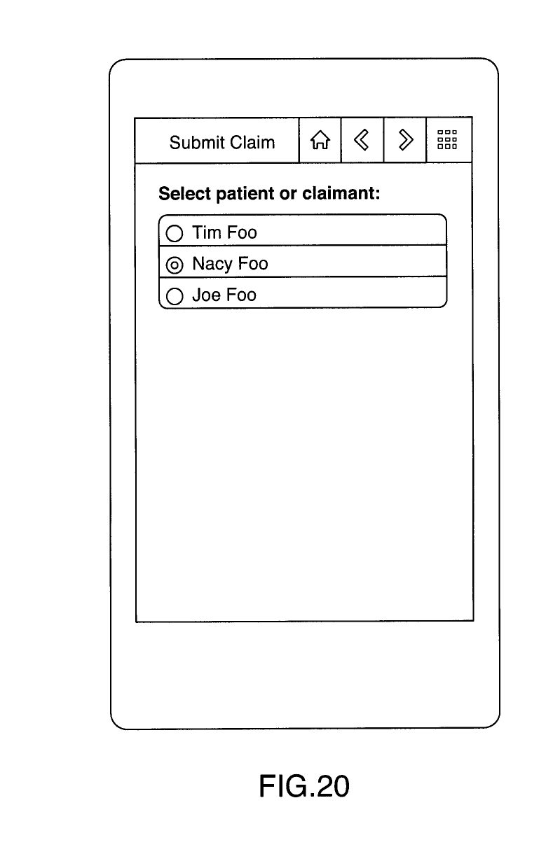

In a preferred embodiment, members/users may submit an electronic request for reimbursement of a claim through a computer or mobile device connected (e.g. wirelessly) to a computer network, such as, for example, the internet, using an interface generically referred to as an online claims access (OCA) tool or web portal (see FIGS. 18 to 26). In a preferred embodiment, the member or user may make the claim submission to the web portal through a web-browser or a web based application either in a desk top computer, internet-ready device, or through a mobile device application. It will be understood, however, that other means for submitting the request for reimbursement of the claim submission may be used, which would be well known to a person skilled in the relevant art such as specific software, including but not limited to, an application. An application is a program that once installed on a device, or accessed through a web-browser enables users to access the interface created to manage and transmit claim submissions and integrated adjudicating capabilities.

FIG. 2 shows a preferred embodiment of a web-portal's claim submission screen, accessible to users to submit claims online. The claims submission screen may be found under a drop-down menu or task bar within the online web-portal In another embodiment, the user or member can initiate the process manually, for example, by selecting an icon on a display screen, selecting a hyperlink (e.g. represented by a “button”), or otherwise inputting a command to present the beginning of the protocol. A preferred embodiment, as show in FIG. 2 provides for a drop down menu or task bar labelled CLAIMS (see 295 of FIG. 2). Once selected, this begins the process of submitting the reimbursement or re-payment of the claim expense. Other drop down menu selections can include, for example, HOME (see 296 of FIG. 2), which, when selected, returns the user to the initial or home screen. In addition, there can be drop down menu selections for PAYMENTS and DOCUMENTATION (297 and 298 of FIG. 2) which can provide a list of payments as well as documents submitted previously In a preferred embodiment, the claims drop-down may also include a section called HISTORY (not shown), where members can see previous claims submitted.

In another embodiment, the command can be as subtle as placing the focus of a web browser on a search field displayed by the web browser application. For example, as a default the process can initiate every 15 minutes, but the user can be permitted to change the default to initiate more or less frequently, on-demand-only, or when his current location has changed by a predefined amount, which the user may also be also to set. Alternatively, the member may simply “click” or select ‘Submit a Claim’ the member may be directed to the new claims submission screen. The claims submission screen may be layered with steps to follow to ensure an easy member experience when submitting a claim electronically. It will be understood that any number of GUI can be applied to commence the claim reimbursement procedure.

In a preferred embodiment, one of the initial steps in submitting a claim is selecting the claim type that is to be adjudicated. Claim types can be broken into categories, including, but not limited to, dental 301, drug 302, health 303, vision 305 and/or hospital expenses 304 (see FIG. 3). It will be understood that other health care related categories or non-health related (e.g. insurance claims) could also be categorized accordingly.

As shown in FIG. 3, members may select the type of claim from a drop-down box. Once the member selects a claim type, the appropriate submission page may populate below based on the type of claim selected (as shown in FIG. 4). It will be understood that claim types visible to members or users are based on parameters set out on the online claims submission screen outlined herein.

As shown in FIG. 4, before claim details (e.g. Submitted Claim Amount, Date of Service) can be entered, the claimant information (e.g. unique ID) must be populated (see 400 of FIG. 4). Members may indicate which claimant incurred the expense. Once the claimant has been selected, the next step in the submission process may appear.

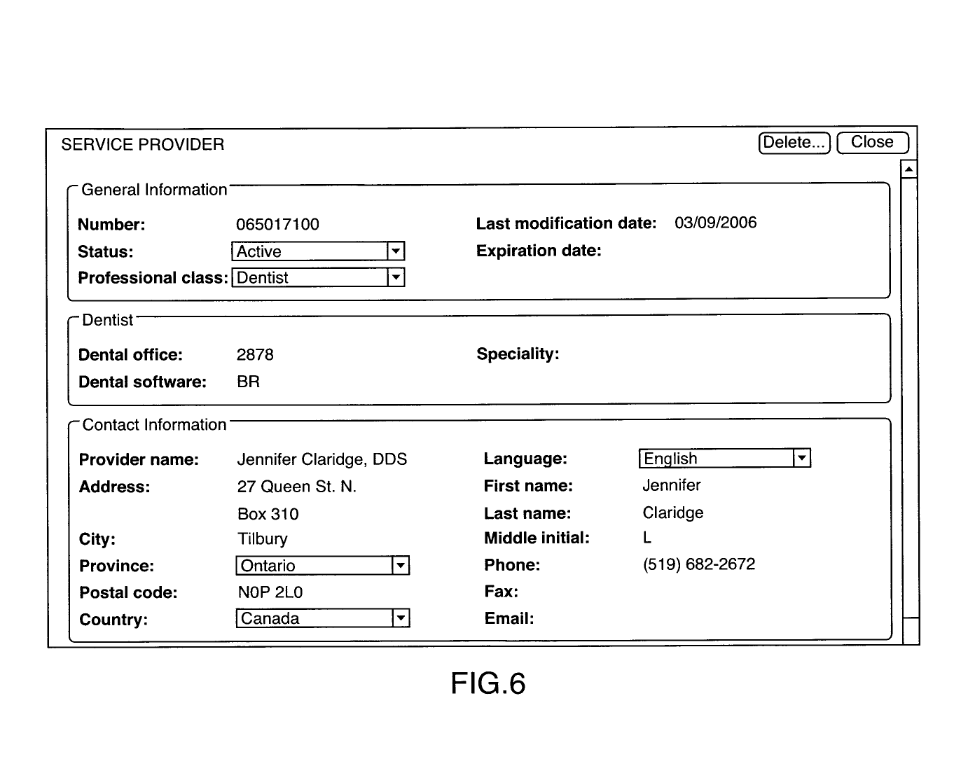

As show in FIG. 5, a further step in the submission process is to select a service provider. Members/users can select from a drop-down list including all service providers with previous claims history (500). Users may search from a pre-existing service provider list, or create their own service provider record (See FIG. 6). When modifying existing providers, a list of existing stored providers may appear. When selecting or “clicking on” a provider, an inline frame or “iframe” (e.g. an HTML document embedded inside another HTML document on a website) may appear with the provider information. Although an iframe behaves like an inline image, it can be configured with its own scrollbar independent of the surrounding page's scrollbar. The iframe may contain the member's existing service providers which can be modified along with the ability to add a new service provider.

In a preferred embodiment, service providers shown in the drop-down list can be specific to the claim type. Members can manage their provider listing by selecting or clicking the link ‘Manage Service Providers’ (see 510 of FIG. 5) and an inline frame or iframe.

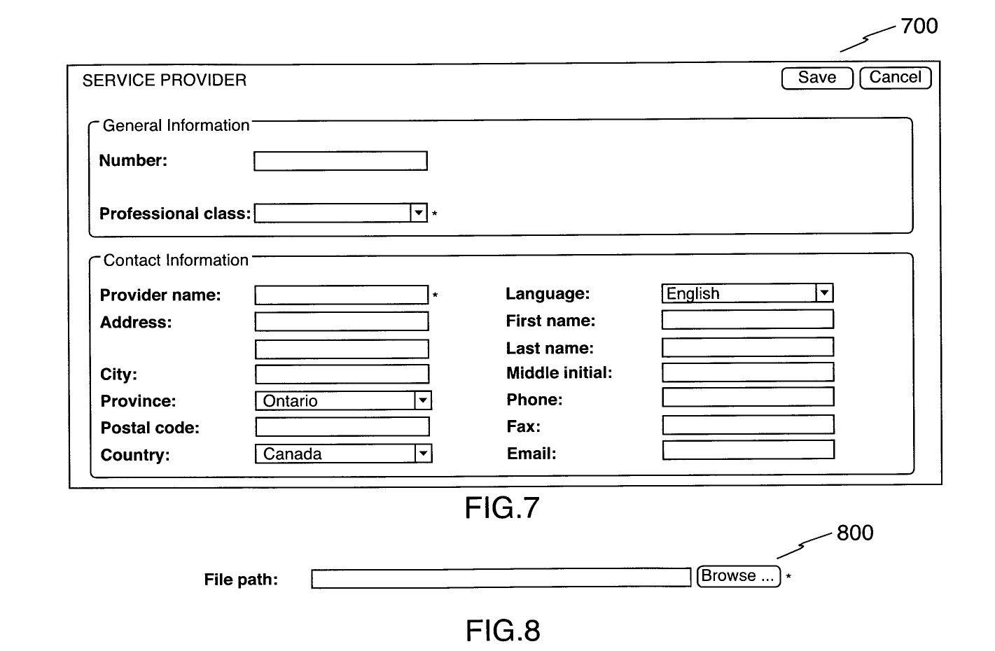

On the member's service provider list screen, an ‘Add a Provider’ button (not shown) may be used to open an iframe with search capabilities to add providers by claim type (see FIG. 7). After filtering to locate a provider, a list of matching results can appear. It will also be understood that a member/user may also locate the service provider by scrolling through a list thereof. When selecting a provider, the member may see the full provider details in an iframe where the service provider information can be added to the member's list. As shown in FIG. 7, when creating a new service provider, members may select the professional class of the provider, their provider ID number, contact information, etc. It will be understood that any applicable information can be included, which may be dictated by the service provided or the claim submission requirements. After saving the service provider, it can be available for use with the claims submission process. In a preferred embodiment, custom service providers may remain unique to a specific user or member. In another preferred embodiment, users can integrate user specific service provider(s) into the list of service providers.

In a preferred embodiment, claims submitted electronically may require a POE/POL to be uploaded in order to validate the claim and assist in the further processing. Members may have the ability to upload a proof of expense as a PDF, image or other computer readable file. In a further preferred embodiment, a payor may require that the POL/POE be uploaded electronically. When submitting a claim through a web browser, the member can upload the file by indicating a file location (see 800 of FIG. 8). In a further preferred embodiment, claims submitted through a mobile networked device may utilize the mobile device's camera functionality allowing members to record a digital image thereof which can be uploaded through an application on the mobile device.

Once a POE/POL has been uploaded successfully, the member can continue with the submission steps. Images uploaded and attached to a claim may be used during the adjudication process (and an audit process, if required) to validate the expense based on the parameters set by the payor. POE/POL may include more than one procedure on a receipt. In a preferred embodiment, each file uploaded may be considered as a separate claim. Alternatively, more than one file may be uploaded per claim. It will be understood that the payor/carrier may dictate the procedures for the uploading of such POL/POE. Once a copy of the POL/POE has been uploaded and attached to a claim, the member can proceed with the entry of the input data. It will be understood that when multiple claims are being submitted, members/users may be able to add the input data separately for each claim or enter input data once for multiple claims where there is overlapping data. Members may be able to input multiple procedures found on the receipt, adding each procedure individually before submitting the claim.

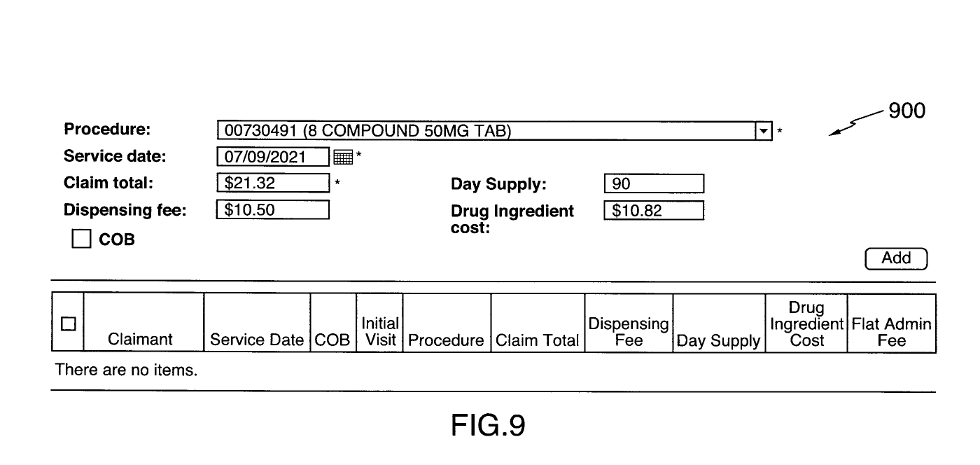

Members may input claim details (e.g. input data) relevant to the claim type selected; it will be understood that this is dependent on the relevant categories as selected by the carrier/payor. As shown in FIG. 9, the claim details required vary by claim type. For example, dental claims may require different fields than prescription drug claims. Insurance claims with regard to a specific property loss may in turn require separate input data as required by the payor/member. In a preferred embodiment, the payor may determine the input data required for a specific claim. When a member begins submitting a claim, the claim details screen (see 900 of FIG. 9) may be based on the claim type selected. It will be understood that any claim specific information can be provided. It will be further understood that there are common elements to each claim (e.g. procedure codes, service dates, professional fees, etc.) and claim specific codes (e.g. lab codes. dispensing fees, etc.; (see, for example, FIG. 14). For example, where the claim is dental related, dental claims can include, but may not be limited to, the following fields: (a) Procedure Code; (b) Service Date; (c) Professional Fee; (d) Lab Fee; (e) Tooth Code: (f) Surface Code; and (g) Coordination of Benefits (COB). In another preferred embodiment, drug claims can include, but may not be limited to, the following fields: (a) Procedure Code (see FIG. 9); (b) Service Date; (c) Dispensing Fee; (d) Claim Total; (e) Drug Ingredient Cost; (f) Day Supply; and (g) Coordination of Benefits (COB). In yet another preferred embodiment, health care related claims can include, but may not be limited to, the following fields: (a) Procedure Code; (b) Service Date: (date range option to/from); (c) Claim Total; and (d) Coordination of Benefits. In yet another preferred embodiment, hospital related claims can include, but may not be limited to, the following fields: (a) Procedure Code; (b) Service Date: (date range option to/from); (c) Claim Total; and (d) Coordination of Benefits shown as: Primary Insurance Paid. In yet another preferred embodiment, vision care related claims can include, but may not be limited to, the following fields: (a) Procedure Code; (b) Service Date; (c) Claim Total; and (d) Coordination of Benefits shown as: Primary Insurance Paid.

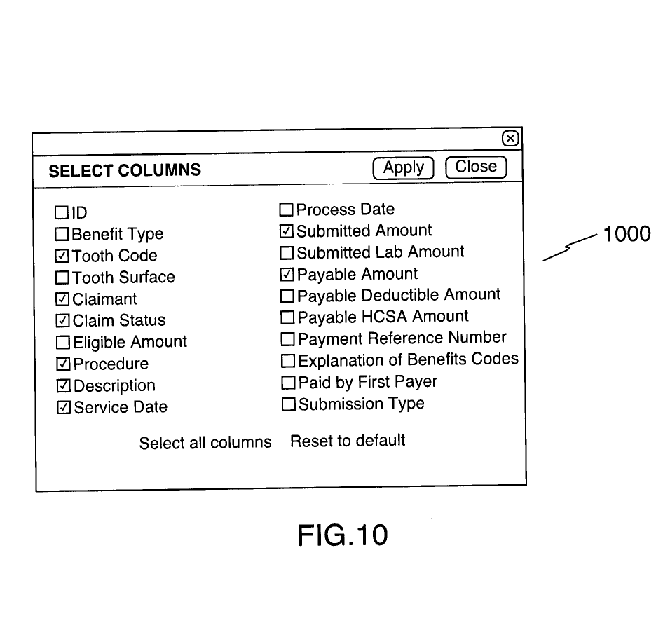

Once the member has submitted the input data, a confirmation page may appear allowing the member to confirm the inputted claim details before proceeding with submitting the claim for adjudication. This screen may be a summary page showing all procedures included in the claim (see 1010 of FIG. 10). Once the member has reviewed the details and accepts the submission, the claim may proceed to adjudication under the applicable adjudication process determined for the particular claim (e.g. what verification data is used, the weighting of such data, etc.) to determine whether the claim should be subject to further review or action.

00102 If the user cancels a claim submission, there may be an option to place a claim on hold (or pending). This feature may be useful to members who begin submitting a claim and do not complete the steps, or if a technical issue is encountered before a claim is successfully submitted. In user preferences there may be the ability for the member to set whether a confirmation (e.g. a claim confirmation email) should be sent once a claim has been submitted. In a preferred embodiment, this could be a generic message body with confirmation information. In a preferred embodiment, users may have the ability to revert a claim for situations where an error was made. In order for claims to be eligible to be reverted they cannot be posted to a payment. If the claim has yet to be posted as a payment, the user may have the ability to revert the submission which would appear in the claims experience as a reversed claim.

00103 Members may be able to reload submissions that were not completed. If a claim is incomplete, it may be stored with the details that were input. When a member attempts to submit a new claim, a message may appear indicating an incomplete claim exists. The member may have the option to reload the incomplete claim, or discard the incomplete claim.

00104 A person skilled in the relevant art will understand that adjudication refers to a pre-audit process whereby, in one embodiment, processing or screening is conducted on a claim for reimbursement by a member or user to determine whether such claim is otherwise ready for payment. A claim which may have successfully undergone an adjudication process may be reimbursed to the user or member. During a preferred adjudication process of the present invention, the applicable information of a user or member is authenticated and graded to determine whether the payor/carrier may pay the requested amount (e.g. reimbursement amount in the case of a claimed expense).

00105 In a preferred embodiment, procedure codes that may be inputted may include, as an example, the following details: (a) Submitted Amount; (b) Fee Guide Adjustment; (c) Deductible Adjustment; (d) Reimbursement Adjustment; (e) Maximum Adjustment; (f) Benefit Plan Amount; (g) HCSA; (h) Cost Plus; (i) Payable Amount; (j) Automatic EOB (explanation of benefits) notes; and (k) Adjudication or Audit Messages.

Adjudication/Audit Messages, for example, may be outlined in the adjudication requirements section. When claims are reviewed and an adjudication or audit may be required, members may receive a message regarding the status of the claim. Adjudication or audit messages may be available in a standard format, or there may also be the option for payors to customize the messaging back to members when a claim is adjudicated/audited. Carriers identify the return messages (e.g. audit or adjudication messages) to be presented to the member/claimant when an online submission has not met the adjudication rules or audit parameters and may be queued for further action.

00106 In a preferred embodiment, a return message may be made available to a user confirming the receipt of the claim, and a message may be returned indicating that the claim is being reviewed pursuant to the adjudication/audit process. A person skilled in the relevant art will understand that the wording of this message may be available in a standard format or payors may have the ability to create their own messaging to be returned when a claim goes into adjudication or audit. An example adjudication message may comprise the following: “Your claim has been received electronically and may be processed within 24 to 48 hours. Once the processing is complete, you may receive confirmation via email.” (see FIG. 25) 00107 In a preferred embodiment, members may assigns benefit payment to a service provider through the process of the present invention; a member may need to indicate a pay-to field where the service provider can be selected for situations where reimbursement of a claim is to be made directly to the service provider. Along with selecting the service provider, a pay-to field may be available to indicate whether the payment is to be made to the payor/carrier or the service provider. In a preferred embodiment, there may be input criteria where the payment of the claimed amount defaults to user, but the member may select a service provider. When a service provider is selected, the member must select the provider from a drop-down menu or task bar. The providers available are based on the member's maintenance settings where service providers are configured. Only service providers within the specific claim type would appear. For example, when submitting a dental claim, only service providers within the dental section would be available.

00108 In a preferred embodiment, a maintenance section may be made available to configure settings for use by payors/carriers. Customizable by the carrier, input and verification data and criteria may be customized by payor, block, group, and class, as an example. Should the payor/carrier wish to update or change the any portion thereof, a portion of the system can accommodate this functionality. It will be understood that the maintenance area for online claims submission may be accessible electronically in a preferred embodiment, such as, for example, by viewing a website.

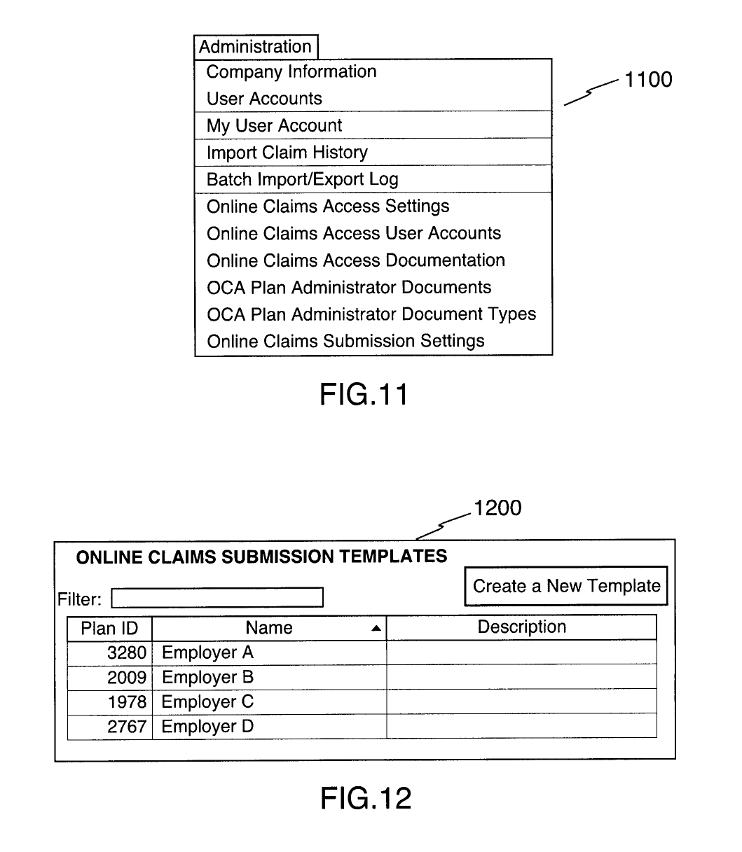

Online Claims Submission Maintenance, which, in a preferred embodiment, may be accessed by payors/carriers only, may be found, in a preferred embodiment, under the Administration section (as shown in FIG. 11). When selecting ‘Online Claims Submission Settings’ (not shown) a maintenance screen 1100 may appear where templates can be created containing input and verification criteria and adjudication rules. Payors can create and manage templates which customize the restrictions in place for members submitting claims online and apply standards which may determine adjudication of such claims.

The maintenance screen may utilize Online Claims Submission Rules Templates (See FIG. 12). Templates are created similar to benefit plans but specific to Online Claims Submission. Templates are created and can be attached to various levels which may provide the framework for managing online claims submission based on payor preferences. Payor preferences may identify the requirements and rules applied when managing claim submission requirements for online claim submissions. Examples of payor preferences include the requirement for uploading a Proof of Expense/Proof of Loss, claim type restrictions for online claims submission, and required fields when inputting claim details. It may be understood that change effective dates may be used to manage changes and amendments to templates; a change log may also be included to track changes made by date, time, and user; templates may be assigned a system generated template number. Change effective dates may be required to manage amendments to Claim Submission Templates.

When accessing the Online Claims Submissions Settings screen, all existing templates may be listed as shown in FIG. 12, as a preferred embodiment. Payors can click on a template name to open an iframe. The iframe may allow payors to edit a template, delete a template and copy a template. Templates cannot be deleted if they are currently in use for an active level (i.e. Block, group, class). A button called ‘Create a New Template’ may also be available when building new templates (See FIG. 12).

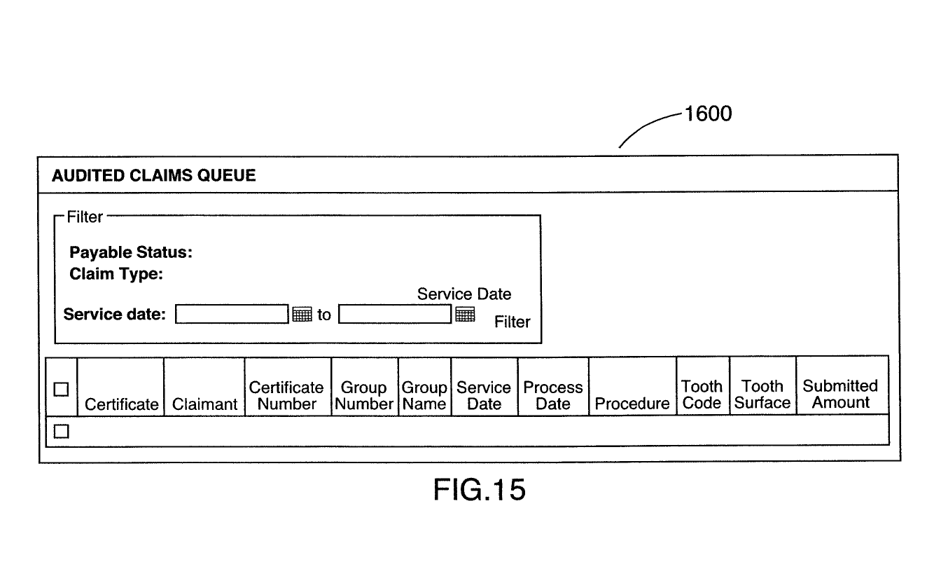

As shown in FIG. 15, the present invention may also provide for an adjudication or audit queue area where payors/carriers can manage claims that have been adjudicated and identified as requiring further follow-up, including an audit. As shown in FIG. 15, the audited claims list 1600 may be located under a specific button in the GUI, such as for example, an E-Claims section. The audited claims list 1620 may be broken down by category and include filtering capabilities to easily locate claims to be audited or a specific audited result. The results shown in the list may be based on the level when accessing the audit queue. For example, if a user is loaded in the tree, only audited claims for the user would appear. If the group is selected in the tree, only results for the group would appear. The filter may allow users to search by process date. Also, checkboxes may be available to select which audit categories should be included in the filter results. Audit categories available that can be include, but are not limited to all adjudication/audit types, graded adjudication/audit, random adjudication/audit, payable amount adjudication/audit, initial adjudication/audit, service provider adjudication/audit, procedure code adjudication/audit, coordination of benefits adjudication/audit, duplicate claims adjudication/audit, etc.

When selecting on an adjudicated or audited claim, an iframe may appear with user actions available. All information submitted along with the applicable procedure may appear, along with a link to access proof of expense receipts. When selecting the link, a .pdf version of the uploaded documents may appear. Details on the audit rule triggered may appear to assist the adjudicator in assessing the claim. The audit condition may appear indicating why the claim was audited, and highlighted fields may indicate areas of the claim that triggered the audit. For example, an audit may be caused by the procedure exceeding the allowable submitted amount, or because the graded audit process does not meet the minimum allowable standard. In these cases, the fields causing the audit to be triggered would be highlighted to increase visibility for the adjudicator.

There may be the option to approve, deny, or close the iframe. When closing the iframe, the audited claim would remain as being unprocessed. When selecting approve or deny, the adjudicator may confirm the action. Once confirmed, the audited claim may no longer be treated as a pended claim.

While a claim is in audit it may be treated as a pended claim. Claims that are pended may be handled similar to a pre-determination. Pended claims due to audit may not count towards annual maximums or unit constraint counts while in a pended state. Pended claims due to audit may be re-adjudicated upon the time of approval. This may ensure if claims were received between the time the claim went into audit and the time the approval took place are accounted for.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. An automated method for adjudicating a claim submitted though a network ready device, the method comprising:
(a) a user manually inputting an alphanumeric value corresponding to a first claim datum, the alphanumeric value obtained from a record, via a GUI in the network ready device, the first claim datum having a value datum and a verification datum pre-assigned thereto, the value and verification datum each having an alphanumeric value;
(b) obtaining an alphanumeric value corresponding to a second claim datum from an electronic copy of the record and comparing the alphanumeric value of the first claim datum with alphanumeric value of the second claim datum and determining if the alphanumeric values of the first and second claim datum are sufficiently similar to be considered to match and where the alphanumeric values of the first and second claim datum match proceeding to step (c);
(c) comparing the alphanumeric value of the first claim datum from step (a) with the value datum, determining if the alphanumeric values of the value datum and the first claim datum are sufficiently similar to be considered to match and where the alphanumeric values of the value datum and the first claim datum match assigning the numeric value of the verification datum to a claim adjudication value;
(d) determining if the claim adjudication value is greater than or equal to an adjudication threshold having an alphanumeric value preassigned thereto wherein:
(i) if the alphanumeric value of the claim adjudication value is not greater than or equal to the alphanumeric value of the adjudication threshold, the claim is targeted for further processing; and
(ii) if the alphanumeric value of the claim adjudication value is greater than or equal to the alphanumeric value of the adjudication threshold the claim is targeted to be paid.

2. The method of claim 1, wherein the record is a proof of loss or expense.

3. The method of claim 2, wherein the proof of loss or expense is scraped to obtain the alphanumeric value of the second claim datum.

4. The method of claim 3, wherein the value datum the verification datum and the adjudication threshold are defined by a payor prior to the submission of the claim by the user.

5. A non-transitory computer readable media having program instructions for causing a computer system to perform a method for adjudicating a claim submitted though a network ready device, the method comprising:
(a) a user manually inputting an alphanumeric value corresponding to a first claim datum, the alphanumeric value obtained from a record, via a GUI in the network ready device, the first claim datum having a value datum and a verification datum preassigned thereto, the value and verification datum having an alphanumeric value;
(b) obtaining an alphanumeric value corresponding to a second claim datum from an electronic copy of the record and comparing the alphanumeric value of the first and second claim datum and if the alphanumeric value of the first and second claim datum are sufficiently similar to be considered to match proceeding to step (c).
(c) comparing the alphanumeric value of the first claim datum with the alphanumeric value of the value datum, determining if the value datum and the first claim datum are sufficiently similar to be considered a match and where the alphanumeric value of the value datum and the first claim datum match assigning the alphanumeric value of the verification datum to a claim adjudication value;
(d) determining if the claim adjudication value is greater than or equal to a pre-defined adjudication threshold having an alphanumeric value preassigned thereto wherein:
(i) if the alphanumeric value of the claim adjudication value is not greater than or equal to the alphanumeric value of the adjudication threshold, the claim is targeted for further processing; and
(ii) if the alphanumeric value of the claim adjudication value is greater than or equal to the alphanumeric value of the adjudication threshold the claim is targeted to be paid.

6. The non-transitory computer readable media of claim 5, wherein the record is a proof of loss or expense.

7. The non-transitory computer readable media of claim 6, wherein the proof of loss or expense is scraped to obtain the alphanumeric value of the second claim datum.

8. The non-transitory computer readable media of claim 7, wherein the value datum, verification datum and the adjudication threshold are defined by a payor prior to the submission of the claim by the user.

9. A computer system performing a method for adjudicating a claim submitted though a network ready device, the system comprising:
(a) a processor; and
(b) a program storage device communicatively coupled to the processor wherein the processor is programmed to:
(i) allow a user to manual input a user manually inputting an alphanumeric value corresponding to a first claim datum, the alphanumeric value obtained from a record, via a GUI in the network ready device, the first claim datum having a value datum and a verification datum pre-assigned thereto, the value and verification datum each having an alphanumeric value;
(ii) obtaining a alphanumeric value corresponding to a second claim datum from an electronic copy of the record; and comparing the alphanumeric value of first claim datum with alphanumeric value of the second claim datum and determining if the alphanumeric values of the first and second claim datum are sufficiently similar to be considered to match and where the alphanumeric values of the first and second claim datum match proceeding to step (iii);
(iii) comparing the alphanumeric value of the first claim datum from step (a) with the value datum, determining if the alphanumeric values of the value datum and the first claim datum are sufficiently similar to be considered to match and where the alphanumeric values of the value datum and the first claim datum match assigning the numeric value of the verification datum to a claim adjudication value;
(iv) determining if the claim adjudication value is greater than or equal to an adjudication threshold having an alphanumeric value preassigned thereto wherein:
(A) if the alphanumeric value of the claim adjudication value is not greater than or equal to the alphanumeric value of the adjudication threshold, the claim is targeted for further processing; and
(B) if the alphanumeric value of the claim adjudication value is greater than or equal to the alphanumeric value of the adjudication threshold the claim is targeted to be paid.

10-15. (canceled)
